(19) United States
(12) Patent Application Publication
(10) Pub. No.: US 2024/0376710 A1
(43) Pub. Date: Nov. 14, 2024

(54) 3D-PRINTED INTEGRATED BUILDING PANEL SYSTEMS

(71) Applicant: Mighty Buildings, Inc., Oakland, CA (US)

(72) Inventors: Aleksei Dubov, San Mateo, CA (US); Anna Ivanova, Monterrey (MX); Anna Khabarova, Reno, NV (US); Svetlana Galaktionova, Monterrey (MX); Sergei Belorustsev, Moscow (RU); Yonah Naftaly, San Mateo, CA (US); Daniel Ramirez, Newburyport, MA (US); Dmitriy Yakimovich, Monterrey (MX); Amichai Becker, Redwood City, CA (US); Sergei Serashev, Monterrey (MX); John Going, Los Angeles, CA (US); Petr Ovchinnikov, Moscow (RU)

(21) Appl. No.: 18/634,320

(22) Filed: Apr. 12, 2024

Related U.S. Application Data
(63) Continuation-in-part of application No. 18/196,829, filed on May 12, 2023.

(51) Int. Cl. E04C 2/20; B33Y 80/00; E04C 2/36

(52) U.S. Cl. CPC E04C 2/20; B33Y 80/00; E04C 2/365

(57) ABSTRACT

A 3D-printed integrated building panel system configured to form a portion of an overall building can include 3D-printed building panels, connectors, and one or more load transfer components. Each 3D-printed building panel can be formed by 3D printing technology using a photocurable composite material, and at least a portion of the 3D-printed building panels can be integrally formed. The connectors can be coupled to one or more of the 3D-printed building panels and can couple the 3D-printed building panels to each other and/or to one or more separate building components of the overall building. The load transfer component(s) can be coupled to at least a portion of the 3D-printed building panels and can transfer loads across the 3D-printed building panels. The load transfer component(s) can be configured to form at least a portion of an overall super structure for the overall building.

### CROSS-REFERENCE TO RELATED APPLICATION

This application is a continuation-in-part of and claims priority to U.S. patent application Ser. No. 18/196,829, filed May 12, 2023, and titled “3D-PRINTED INTEGRATED WALL PANEL ASSEMBLY,” which is incorporated herein by reference in its entirety.

### TECHNICAL FIELD

The present disclosure relates generally to three-dimensional printing, and more particularly to the three-dimensional printing of building elements, components, and structures.

### BACKGROUND

Traditional residential and commercial building planning and construction processes can be complicated and inefficient. Such processes may involve designing the building, creating a floor plan, obtaining permits, hiring architects, contractors, carpenters, electricians, plumbers, and other professionals, and incurring inspections of the building structures at various times during construction. Numerous disparate processes and materials are typically required to form foundations, framing, plumbing, electrical systems, drywall, and the like. Construction of a new building often takes many months to complete and requires multiple contractors, specialists, workers, and various inspections as construction proceeds. Final construction is usually achieved by combining several construction materials of various nature. For example, a main structure may be accompanied by a metal frame to increase wall-bearing capacity, as well as one or more coatings to provide better environmental resistance.

Many industries are changing due to the transformative technologies of three-dimensional (“3D”) printing, but few can compare to the disruptions that are coming to building construction. Many new technologies focus on 3D printing buildings on-site using various concrete mixtures. These approaches face serious challenges due to material limitations such as low thermal efficiency, lack of automation capabilities (one still needs to install steel rebars manually), printed surfaces appearing very raw, and the inability to post-process using robotics or other automation, among various other issues. Printing on-site can also be inefficient because printing equipment requires lots of setup, calibration, and disassembly work, in addition to manual finishing work, among other issues. Printability (e.g., structural integrity) and post-print properties (e.g., interface strength) of concrete mixtures can be highly dependent on printing parameters that pose considerable challenges in deciding on the rheological properties of fresh concrete, and the printing strategy itself.

Some of these concerns are addressed, for example, by Hossain, Md, et al. “A Review of 3D Printing in Construction and its Impact on the Labor Market” Sustainability 12.20 (2020): 8492; Camacho, Daniel Delgado, et al. “Applications of additive manufacturing in the construction industry-a prospective review” ISARC. Proceedings of the International Symposium on Automation and Robotics in Construction. Vol. 34. IAARC Publications (2017); Camacho, Daniel Delgado, et al. “Applications of additive manufacturing in the construction industry-A forward-looking review” Automation in construction 89 (2018): 110-119; Mohan, Manu K., et al. “Extrusion-based concrete 3D printing from a material perspective: A state-of-the-art review” Cement and Concrete Composites (2020): 103855; and Han, Yilong, et al. “Environmental and economic assessment on 3D-printed buildings with recycled concrete” Journal of Cleaner Production 278 (2021): 123884, among others.

Structural performance and reinforcement of 3D-printed structures and elements, process reliability and limitations, and regulatory challenges are three main existing concerns that hinder the widespread use of automated construction technologies, and all of these concerns are related to 3D printing with concrete. Concrete mixtures cannot be used for load-bearing walls without reinforcement, since as a structural material they provide compressive strength, but not tensile strength. Conventional load-bearing concrete can only be used with reinforcement, usually steel rebar, which is typically installed manually but is not connected to a printed shell. To achieve high performance of a wall structure having steel bars or other reinforcement, contractors typically add concrete aggregates inside a shell structure, which makes it impossible to automate the reinforcement process.

Another challenge for 3D printing processes using concrete is that conventional steel reinforcement is challenging to incorporate into a 3D printing process. Another disadvantage of using concrete in 3D printing is that it generally takes a long time for concrete to solidify or otherwise cure and gain a required level of strength. Such materials thus generally cannot meet performance requirements regarding rapidly solidifying the subject material in a short period of time. Even though the speed of solidification can be increased by changing the formulation, such an increase is usually limited or difficult to control and makes 3D printing impractical for certain circumstances such as constructing a building on a construction site.

In order to support additional layers, the printing process must be stopped to allow the lower layers to cure to the necessary strength, which can take hours or even days in some cases. Breaks are also necessary to pour concrete aggregate inside the printed shell without breaking it to ensure proper reinforcement. The higher the wall the more chance that poured concrete breaks the wall structure during the curing process. Printing breaks have a significant impact on mechanical performance, causing so-called cold joints where the layers do not adhere properly and layer delamination occurs.

In many cases of using concrete as a material for 3D printing of buildings, a wall is a combination of a 3D-printed concrete shell, poured concrete aggregate, and steel reinforcement. There is little room left for thermal insulation, which can only be applied to the outside of the wall either interior or exterior, which is a process that is difficult to automate and requires additional time and/or materials.

Another challenge is that without additional support structures, only vertical walls and domed roofs can be printed. 3D printing concrete-based formulations have long curing and strength gain time periods, such that an entire element or object cannot be completed in a single print cycle. Limitations in vertical extrusion (i.e., layer-by-layer) processes require additional manual work to create support for overhangs. Furthermore, printing of complex infill structures (i.e., internal structures of a 3D-printed part) or freeform architectural features from concrete is generally not possible.

Cracking and reduction in fracture resistance are known issues for 3D-printed concrete building structures. 3D-printed concrete accelerates the evaporation of water, which increases shrinkage and the risk of cracking (lack of formwork to protect against air exposure). Environmental factors such as hydrostatic pressure and temperature can weaken the mechanical properties of extruded concrete and lead to unevenness.

Companies utilizing concrete as a material for 3D printing usually use 3D printers at the construction site because concrete blocks are too heavy to transport. The use of prefab structures is not reasonable with each project requiring complex setup/calibration of the printer on-site, as well as greatly limiting the locations where 3D printing technology can be deployed.

Additional issues persist with 3D printing building structures. For example, existing commercialized 3D printed construction solutions typically involve either onsite cementitious printing or monolithic offsite printing, and these two basic types of 3D printing processes are limited by the size of the printer, which is often a gantry type of machine. This size limitation then results in a lack of verticality in that the printed building structures cannot be larger than one or two stories. These types of 3D printing processes also have limited design flexibilities as the resulting designs must typically incorporate a cementitious finish.

Although traditional ways of forming residential and commercial buildings and elements thereof using 3D printing have worked well in the past, improvements are always helpful. In particular, what is desired is the reduction or elimination of concrete and other traditional construction materials to form building elements and systems thereof that are suitable for use in multi-story structures for reduced costs and taking lesser periods of time without sacrificing required or desirable performance properties.

### SUMMARY

It is an advantage of the present disclosure to provide building elements, components and structures having limited to no concrete and other traditional construction materials that are usable in multi-story structures for reduced costs and lesser building times without sacrificing performance properties. The disclosed features, apparatuses, systems, and methods relate to 3D-printed building elements, components, systems, and structures, and in particular building elements and systems that integrate 3D-printed components, such as 3D-printed integrated building panel systems that are suitable for use in multi-story building structures.

In various embodiments of the present disclosure, a 3D-printed integrated building panel system configured to form a portion of an overall building can include a plurality of 3D-printed building panels, a plurality of connectors, and one or more load transfer components. The plurality of 3D-printed building panels can be formed by 3D printing technology using a photocurable composite material, and at least a portion of the 3D-printed building panels can be integrally formed. The plurality of connectors can be coupled to one or more of the 3D-printed building panels and can be configured to couple the 3D-printed building panels to each other, to one or more separate building components of the overall building, or to any combination thereof. The one or more load transfer components can be coupled to one or more of the 3D-printed building panels and can be configured to transfer loads across the 3D-printed building panels. The one or more load transfer components can be configured to form at least a portion of an overall super structure for the overall building.

In various detailed embodiments, the 3D-printed integrated building panel system can form a modular unit configured to be readily installed to the overall building during construction. The one or more load transfer components can include one or more horizontally oriented beams, one or more vertically oriented columnar members, or both, and the one or more load transfer components can combine to form a frame support super structure. In some arrangements, the one or more load transfer components can include one or more steel I-beams, W-beams, hollow structural sections, or any combination thereof. The plurality of 3D-printed building panels can include at least one straight panel, at least one corner panel, and at least one column hider panel.

In further detailed embodiments, at least one of the 3D-printed building panels can include one or more vertically oriented slots formed into its top surface or edge, its bottom surface or edge, or both. Such vertically oriented slots can be configured to accept one or more connectors inserted therein to facilitate coupling to one of the load transfer components. In some arrangements, at least one of the 3D-printed building panels can include an outer frame shell defining a geometric shape having an interior outer surface, an exterior outer surface, side edges between the interior and exterior outer surfaces, and an infill structure within the outer frame shell, the infill structure forming internal cavities within the outer frame shell. In addition, the 3D-printed integrated building panel system can meet construction industry requirements regarding structural performance, thermal efficiency, fire performance, and waterproofing. The one or more separate building components of the overall building can include one or more window frames, door frames, traditional wall segments, foundations, or any combination thereof. At least a portion of the plurality of connectors can be coupled directly to at least a portion of the one or more load transfer components.

In various further embodiments of the present disclosure, a building panel configured to form a portion of a 3D-printed integrated building panel system that is in turn configured to form a portion of an overall building can include at least a 3D-printed structure. This 3D-printed structure can be integrally formed by 3D printing technology using a photocurable composite material. The 3D-printed structure can include at least an outer frame shell and one or more coupling features. The outer frame shell can define a geometric shape having an interior outer surface, an exterior outer surface, and side edges between the interior outer surface and exterior outer surface. The one or more coupling features can be formed along edges of the 3D-printed structure, and these coupling features can be configured to facilitate coupling the 3D-printed structure to a load transfer component within the 3D-printed integrated building panel system. The load transfer component can be configured to form at least a portion of an overall super structure for the overall building.

In various detailed embodiments, the 3D-printed structure can further include an infill structure within the outer frame shell, with this infill structure forming internal cavities within the outer frame shell. The one or more coupling features formed in the 3D-printed structure can include one or more vertically oriented slots formed into top and bottom edges thereof. The one or more vertically oriented slots can be configured to accept one or more connectors inserted therein to facilitate coupling the 3D-printed structure to the load transfer component. In some arrangements, the building panel can form a modular unit configured to be readily installed to the 3D-printed integrated building panel system. The load transfer component can be a horizontally oriented beam or a vertically oriented columnar member, and can be a steel I-beam, W-beam, or hollow structural section. In some embodiments, the building panel can also include the load transfer component itself. Also, the interior outer surface and/or the exterior outer surface of the 3D-printed structure can be covered by one or more finishing coatings.

In various other embodiments of the present disclosure, a building element configured to form a portion of an overall building can include a plurality of 3D-printed panels, a plurality of connectors, and one or more load transfer components. The plurality of 3D-printed panels can be formed by 3D printing technology using a photocurable composite material. Each of at least a portion of the plurality of 3D-printed panels can be integrally formed and can include an outer frame shell defining a geometric shape having an interior outer surface, an exterior outer surface, and side edges between the interior and exterior outer surfaces, and an infill structure within the outer frame shell, the infill structure forming internal cavities within the outer frame shell. The plurality of connectors can be coupled to at least a portion of the plurality of 3D-printed panels and can be configured to couple one or more of the 3D-printed panels to each other, to one or more separate building components of the overall building, or to any combination thereof. The one or more load transfer components can be coupled to at least a portion of the plurality of 3D-printed panels and configured to transfer loads across one or more of the 3D-printed panels.

In various detailed embodiments, the building element can meet construction industry requirements regarding structural performance, thermal efficiency, fire performance, and waterproofing. The building element can be a 3D-printed integrated wall panel assembly and the overall building can be a residential or commercial building. At least one interior outer surface, at least one exterior outer surface, or both can be covered by one or more finishing coatings. The building element can also include one or more waterproofing components coupled to at least a portion of the plurality of 3D-printed panels. Such one or more waterproofing components can be installed along one or more horizontal or vertical edges of coupled 3D-printed panels. The shape and the size of a given infill structure can determine the stiffness and the ultimate load bearing capacity of its respective 3D-printed panel. Also, the shape and the size of a given infill structure can determine the thermal efficiency of its respective 3D-printed panel by extending one or more thermal bridging paths within its respective 3D-printed panel. The building element can also include a thermal insulation material disposed within at least some of the internal cavities of at least a portion of the plurality of 3D-printed panels.

In further detailed embodiments, at least some of the side edges can include extrusions that form vertical decorative ledges configured to bridge juncture regions between adjacent 3D-printed panels. Also, the one or more separate building components of the overall building can include one or more window frames, door frames, traditional wall segments, foundations, or any combination thereof. The plurality of connectors can include one or more mechanical connectors, one or more chemical adhesives, or any combination thereof. At least a portion of the plurality of connectors can be coupled directly to at least a portion of the one or more load transfer components. Also, the plurality of connectors can include a rim track with slots formed therein configured to couple to a separate floor component or a separate roof component of the overall building. At least a portion of the plurality of 3D-printed panels can include an opening therethrough configured for a window or a door. In various arrangements, the one or more load transfer components can include one or more sets of tension transmitting members. The one or more load transfer components can include a structural steel frame coupled to a first panel of the plurality of 3D-printed panels to form an integrated panel assembly, and the structural steel frame can include a top frame member, a bottom frame member spaced apart from the top frame member, and columnar members extending between the top and bottom members. In such arrangements, the first panel can include a plurality of vertically oriented slots formed into top and bottom surfaces thereof, and the building element can also include one or more insertion plates inserted into one or more of the plurality of vertically oriented slots, wherein the one or more insertion plates are attached to the structural steel frame to couple the first panel to the structural steel frame. In such arrangements, the building element can further include one or more base plates coupled to one or more of the columnar members and to one or more of the insertion plates inserted into one or more vertically oriented slots along the bottom of the first panel, wherein the one or more base plates are configured to couple the integrated panel assembly to a separate building component of the overall building. Such an integrated panel assembly can be an integrated wall panel assembly and the separate building component can be a foundation of the overall building.

In still further embodiments of the present disclosure, a building panel configured to form a portion of an overall building can include a 3D-printed structure and one or more coupling features formed therein. The 3D-printed structure can be formed by 3D printing technology using a photocurable composite material. The 3D-printed structure can be integrally formed and can includes an outer frame shell defining a geometric shape having an interior outer surface, an exterior outer surface, and side edges between the interior outer surface and exterior outer surface, and an infill structure within the outer frame shell, the infill structure forming internal cavities within the outer frame shell. The one or more coupling features can be configured to facilitate coupling the 3D-printed structure to one or more separate building components of the overall building.

In various detailed embodiments, the building panel can also include a load transfer system formed from non-3D-printed material and coupled to the 3D-printed structure. The load transfer system can be configured to transfer loads across the 3D-printed structure, and the 3D-printed structure and the load transfer system can combine to form a 3D-printed integrated panel. The load transfer system can include a structural steel frame including a top frame member, a bottom frame member spaced apart from the top frame member, and columnar members extending between the top and bottom members. In some arrangements, the one or more coupling features formed in the 3D-printed structure can include a plurality of vertically oriented slots formed into top and bottom surfaces thereof, and the building panel can further include one or more insertion plates inserted into one or more vertically oriented slots. Such one or more insertion plates can be attached to the structural steel frame to couple the 3D-printed structure to the structural steel frame. The building panel can also include one or more base plates coupled to one or more of the columnar members and to one or more of the insertion plates inserted into one or more vertically oriented slots along the bottom of the 3D-printed structure, and the one or more base plates can be configured to couple the 3D-printed integrated panel to a separate building component of the overall building.

In further detailed embodiments, the interior outer surface, the exterior outer surface, or both can be covered by one or more finishing coatings. The building panel can also include a thermal insulation material disposed within at least some of the internal cavities. Also, the 3D-printed structure can have a width of about 1 to 12 feet, a height of about 8 to 12 feet, and a thickness of about 1 to 12 inches. In some arrangements, the outer frame shell of the 3D-printed structure can define a geometric shape that is straight between the side edges to form a straight panel. In some arrangements, the outer frame shell of the 3D-printed structure can define a geometric shape that is complex between the side edges to form a complex panel. Such a complex panel can define a complex geometric shape that is curved, wavy, round-cornered, or square-cornered.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible features, structures, arrangements, systems, and methods for creating 3D-printed integrated wall and building systems, panels, and assemblies. It will be understood that various aspects and features of the disclosed embodiments may be shown in exaggerated or enlarged form to facilitate understanding such that the drawings are not necessarily to scale. These drawings in no way limit any changes in form and detail that may be made to the disclosure by one skilled in the art without departing from the spirit and scope of the disclosure.

FIG. 1 illustrates in rear perspective view an interior region of an example 3D-printed integrated wall panel assembly according to one embodiment of the present disclosure.

FIG. 2A illustrates in rear perspective view an interior region of an example 3D-printed straight wall panel according to one embodiment of the present disclosure.

FIG. 2B illustrates in front perspective view an exterior region of the 3D-printed straight wall panel of FIG. 2A according to one embodiment of the present disclosure.

FIG. 3A illustrates in rear perspective view an interior region of an example 3D-printed integrated outside corner wall panel according to one embodiment of the present disclosure.

FIG. 3B illustrates in front perspective view an exterior region of the 3D-printed integrated outside corner wall panel of FIG. 3A according to one embodiment of the present disclosure.

FIG. 3C illustrates in rear perspective view an interior region of an example 3D-printed integrated inside corner wall panel according to one embodiment of the present disclosure.

FIG. 3D illustrates in front perspective view an exterior region of the 3D-printed integrated inside corner wall panel of FIG. 3C according to one embodiment of the present disclosure.

FIG. 4A illustrates in top cross-section view an example 3D-printed straight wall panel with no infill structure according to one embodiment of the present disclosure.

FIG. 4B illustrates in top cross-section view an example 3D-printed straight wall panel with an infill structure according to one embodiment of the present disclosure.

FIG. 4C illustrates in top cross-section view an example 3D-printed straight wall panel with an alternative infill structure according to one embodiment of the present disclosure.

FIG. 4D illustrates in top cross-section view an example alternative 3D-printed straight wall panel with a complex infill structure according to one embodiment of the present disclosure.

FIG. 5 illustrates in top cross-section view an example 3D-printed outside corner wall panel with an infill structure according to one embodiment of the present disclosure.

FIG. 6 illustrates in top cross-section view an example 3D-printed inside corner wall panel with an infill structure according to one embodiment of the present disclosure.

FIG. 7 illustrates in top cross-section view an example juncture region between two 3D-printed integrated straight wall panels according to one embodiment of the present disclosure.

FIG. 8 illustrates in top cross-section view an example juncture region between a 3D-printed integrated straight wall panel and a window according to one embodiment of the present disclosure.

FIG. 9 illustrates in top cross-section view an example juncture region between a 3D-printed integrated straight wall panel and a 3D-printed integrated outside corner wall panel according to one embodiment of the present disclosure.

FIG. 10 illustrates in top cross-section view an example juncture region between a 3D-printed integrated straight wall panel and a 3D-printed integrated inside corner wall panel according to one embodiment of the present disclosure.

FIG. 11A illustrates in rear perspective view an interior region of an example 3D-printed integrated straight wall panel according to one embodiment of the present disclosure.

FIG. 11B illustrates in front perspective view an exterior region of the 3D-printed integrated straight wall panel of FIG. 11A according to one embodiment of the present disclosure.

FIG. 12 illustrates in side cross-section view an example 3D-printed integrated wall panel according to one embodiment of the present disclosure.

FIG. 13 illustrates in front perspective view an example building formed using 3D-printed integrated wall panel assemblies according to one embodiment of the present disclosure.

FIG. 14A illustrates in rear perspective view an interior region of an example 3D-printed integrated building panel system according to one embodiment of the present disclosure.

FIG. 14B illustrates in side cross-section view the system of FIG. 14A according to one embodiment of the present disclosure.

FIG. 14C illustrates in close up side cross-section view a bottom portion of the system of FIG. 14B according to one embodiment of the present disclosure.

FIG. 15A illustrates in rear perspective view an interior region of an example 3D-printed integrated outside corner panel for a building panel system according to one embodiment of the present disclosure.

FIG. 15B illustrates in front perspective view an exterior region of the 3D-printed integrated outside corner panel of FIG. 15A according to one embodiment of the present disclosure.

FIG. 15C illustrates in rear perspective view an interior region of an example 3D-printed integrated inside corner building panel for a building panel system according to one embodiment of the present disclosure.

FIG. 15D illustrates in front perspective view an exterior region of the 3D-printed integrated inside corner building panel of FIG. 15C according to one embodiment of the present disclosure.

FIG. 16 illustrates in top cross-section view an example 3D-printed integrated outside corner panel for a building panel system with an infill structure according to one embodiment of the present disclosure.

FIG. 17 illustrates in top cross-section view an example 3D-printed integrated inside corner panel for a building panel system with an infill structure according to one embodiment of the present disclosure.

FIG. 18A illustrates in rear perspective view an interior region of an example 3D-printed integrated straight building panel for a building panel system according to one embodiment of the present disclosure.

FIG. 18B illustrates in front perspective view an exterior region of the 3D-printed integrated straight building panel of FIG. 18A according to one embodiment of the present disclosure.

FIG. 19A illustrates in side cross-section view an example 3D-printed integrated building panel according to one embodiment of the present disclosure.

FIG. 19B illustrates in close up side cross-section view a top portion of the building panel of FIG. 19A according to one embodiment of the present disclosure.

FIG. 19C illustrates in close up side cross-section view a bottom portion of the building panel of FIG. 19A according to one embodiment of the present disclosure.

FIG. 20 illustrates in front perspective view an example building formed using 3D-printed integrated building panel systems according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure generally relates to structures, arrangements, systems, and methods for forming wall panels and assemblies that reduce or eliminate the use of concrete and other conventional construction materials. The present disclosure further relates to 3D-printed integrated building panel systems configured to form a portion of an overall building, with such systems including components that facilitate the construction of multi-story buildings that incorporate 3D-printed panels and assemblies. Such buildings can include 1 to 3 story single family homes, 1 to 3 story attached and detached townhomes, and multi-story multifamily homes, among other possible building structures.

The disclosed embodiments involve scaling 3D printing technologies in civil engineering and architectural practice to achieve advantages in producing building elements, segments, or assemblies of complex geometries that can withstand required loads without expensive methods of reinforcing these structures on-site or during the assembly process. Another advantage of the disclosed 3D-printed wall panels and assemblies is the ability to withstand loads during various manufacturing processes like pouring high-density foams into the wall structure to increase overall insulating power of resistance to heat flow.

As noted above, three primary existing concerns in construction technologies include structural performance and reinforcement of building structures and elements, process reliability and limitations, and regulatory challenges. Again, these concerns are all generally related to 3D printing with concrete. Concrete mixtures typically cannot be used for load-bearing walls without reinforcement, since as a structural material concrete provides compressive strength but not tensile strength. Conventional load-bearing concrete can only be used with reinforcement, usually steel rebar. Such steel rebars are typically installed manually but are not connected to any concrete printed shell. To achieve optimal performance of a concrete wall structure and steel bar reinforcement arrangement, contractors typically add concrete aggregates inside the shell structure, which makes it impossible to automate the reinforcement process.

Another challenge for 3D printing processes with concrete is that conventional steel reinforcement is challenging to incorporate into the 3D printing process. There are some efforts that use alternative reinforcements and types of cement using basalt and other materials, although these may be considered inferior. Another disadvantage of using concrete in 3D printing is that it takes long periods of time for concrete to solidify or otherwise cure and gain the required strength. Such materials generally cannot meet performance requirements requiring the material to rapidly solidify in a short period of time. Even though the speed of solidification can be increased by changing the concrete formulation, such an increase is usually limited or difficult to control and makes 3D printing impractical for certain circumstances such as constructing a building on a construction site.

In order to support additional layers, a 3D printing process involving concrete must be stopped to allow lower layers to cure to the necessary strength, which can take hours or even days in some cases. Breaks are also necessary to pour concrete aggregate inside the printed shell without breaking it to ensure proper reinforcement. The higher the wall, the more chance that poured concrete breaks the wall structure during the curing process. Printing breaks have a significant impact on mechanical performance, causing so-called cold joints where the layers do not adhere properly and layer delamination occurs.

In many common use cases for concrete as a material for the 3D printing of buildings and building components, the wall is a combination of a 3D-printed concrete shell, poured concrete aggregate, and steel reinforcement. There is little room left for thermal insulation, which can only be applied to the outside of the wall (either interior or exterior)—a process that is hard to automate and requires additional time and materials. Another challenge is that without additional support structures, only vertical walls and domed roofs can be printed. 3D printing concrete-based formulations have a long curing and strength gain time, such that an entire object cannot be completed in a single print cycle. Limitation in vertical extrusion (layer-by-layer) requires additional manual work to create support for overhangs. Printing of complex infill structures (i.e., internal structures of a 3D-printed part) or freeform architectural features from concrete is generally not possible.

Cracking and reduction in fracture resistance are known issues for 3D-printed concrete building structures. 3D-printed concrete accelerates the evaporation of water, which increases shrinkage and the risk of cracking due to the lack of formwork to protect against air exposure. Environmental factors such as hydrostatic pressure and temperature can weaken the mechanical properties of extruded concrete and lead to unevenness. Companies utilizing concrete as a material for 3D printing usually use 3D printers at the construction site because concrete blocks are too heavy to transport. The use of prefab structures is not reasonable with each project requiring complex setup/calibration of the printer on-site, as well as greatly limiting the locations where 3D printing technology can be deployed.

These disadvantages of 3D printing using concrete can be eliminated by using a composite material that hardens under the influence of ultraviolet (“UV”) light. A photopolymer composite material construction material combines properties of a polymer matrix and inorganic fillers, which have a dense, non-porous structure. The material comprises a base photopolymer, ensuring layers chemically adhere to each other during the printing process. With the layer-by-layer deposition of the material in the 3D printing process, each new curable layer can be firmly fixed to the previous one due to the chemical adhesion between the liquid and cured polymer matrix. The photopolymer composite material forms a solid monolithic structure with layer-by-layer curing. Polymer and inorganic parts of the compound act synergistically, the polymer matrix provides high compressive strength, as well as coats the filler particles, protecting them against aggressive environmental exposures (moisture, acids, alkali, etc.). Further, the presence of inorganic components decreases the plasticity of the photopolymer composite, resulting in higher tensile strength. Further details regarding such 3D printing construction can be found in, for example, U.S. Pat. Nos. 11,267,913 and 11,230,615, which are incorporated by reference herein.

The use of modern composite materials for 3D printing in the construction industry can achieve several goals that improve the construction process in general, such as reducing construction waste, significantly reducing construction process times, and allowing for the creation of a variety of building components. All materials used in 3D printing building components and structures made from such materials should and can still meet certain requirements for performance, serviceability, operation, and safety to the same extent as all other traditional building materials. The 3D printed construction structure should and can comply with the same construction standards as the traditional built building and modules. In addition, performance requirements for the 3D-printed building materials are also determined by their response to external factors such as wind pressure, air tightness, water tightness, thermal efficiency, sound insulation, and fire resistance. A 3D-printed structure intended for construction should and can be resistant to axial and transverse loads (structural load-bearing capacity). A structure printed on a 3D printer should be fire-resistant to withstand heat and open flame from an external source. It should also be thermally resistant to the transfer of heat through the material or structure, as well as to the penetration of water vapor through the material. The 3D-printed structure should also prevent sound waves from permeating through the material or structure and resist air leakage and water penetration through the structure under air pressure difference.

The present disclosure involves building panelized systems including 3D-printed panels that are engineered to meet specific performance requirements, such as varying panel thickness to affect structural performance, core materials, and 3D-printed infill structure to affect thermal efficiency, rigidity, and strength, and panel shape to meet a variety of design requirements. This adaptability allows for customized performance for a wide range of end-use applications. The 3D-printed wall panels and assemblies disclosed herein are designed as non-load-bearing exterior wall cladding that can withstand wind loads of up to 200 mph and are resilient to wind-borne debris impact and heavy rain. The steel frame supporting the 3D-printed panel absorbs and distributes all other types of loads and can be designed for a variety of end-use applications and seismic conditions. The disclosed wall panels and assemblies meet the energy efficiency requirements of Green Homebuilding and have a variable thickness and insulation core, allowing the product to be used in a wide range of climatic zones around the world. The thermal resistance value (e.g., R-value) of the panels can vary from R-19 to R-38 depending on the panel design. Assembly of 3D-printed wall panels also ensures that the building envelopes are impermeable to water or air infiltration. Furthermore, the disclosed 3D-printed wall panels can involve customizable designs having satisfactory acoustic behaviors (expressed in terms of sound reduction index Rw) that meet requirements imposed by current building regulations.

Use of the disclosed building panelized components, assemblies, and systems in construction can significantly save overall time and costs by reducing the time required for installation of external surface decorative protective layers, preparatory painting, and decorating of panel internal surfaces. As a result, the costs of developing construction labor and their performance can be drastically reduced.

The present disclosure relates in various embodiments to structures of the building elements which are produced by means of additive manufacturing (i.e., 3D printing) processes. Formulation of the polymer composite used in the 3D printing process can take the place of cement, wood, steel, drywall, and other structural materials to form foundations, structural support members, floors, walls, ceilings, roofs, and other structural elements. In some arrangements, various building elements and sub-structures can be 3D-printed in a modular fashion at one location and then assembled at a construction site at a later time.

Various disclosed embodiments can include a wall panel configured for attachment to the surface of a building, said wall panel comprising exterior and interior members, and a plurality of cross-members formed by the sequential layering of a polymer composite material using a 3D printing system with a photocurable composition. In particular, the disclosed embodiments can utilize an extrusion-based 3D printing process of wall systems and building elements of a wide variety of sizes and complex shapes, such as linear, corner, curved, and the like, with specially formulated composite polymer materials having material properties that meet or exceed standard building codes. The material used for the 3D printing process may be a composite material that includes a specialized photocurable composition polymer formulation embedded with functional fillers or/and continuous fiber reinforcement.

In various detailed examples, which are merely illustrative and non-limiting in nature, a 3D printing manufacturing process can involve a layer-by-layer extrusion process where each layer is dynamically cured by exposure to UV light or another curing initiator. The disclosed embodiments can include high-strength structural members of the wall panel comprising continuous fiber reinforcement which secures the layers of the panels against brittle failure. Such an approach may be applied to producing geometrically complex components for building large-scale structures such as building elements and buildings with innovative customized designs. Fiber reinforcement can significantly enhance the mechanical properties of the 3D-printed parts as well as impact the strength of the composite materials and can also reduce material usage and cost. In some arrangements, a printed wall structure can include a core shell structure with fiber strand(s) distributed around a central axis across each deposited layer in the longitudinal direction.

In various embodiments, panels can be factory-assembled 3D-printed polymer-based composite panels with a polyurethane foam insulation. Such panels can be 3D-printed with an acrylate polymer combined with inorganic fillers and can be reinforced with continuous fibers deposited longitudinally within each printed layer. Layers of the composite panel can create a closed, hollow shell, which can then be injected with polyurethane foam in the factory. The panels can be attached to load-bearing structural steel frame assemblies.

A 3D-printed composite wall panel supported by steel or timber-braced frame members can be used to construct a wall or wall system. The wall can be printed in such a way that the structure includes a pair of side extrusions at the respective side edges of the wall. Each side edge can be used as a connector for sequential connections of the wall structures to form a building envelope. Connections between panels can include mechanical connectors, chemical adhesives, and/or any other suitable connector. A mechanical attachment system can include a plurality of locking members secured directly to the surface of the 3D-printed wall panels, while chemical adhesives can include two-component epoxy glue or other substances providing high adhesion strength to the printed surfaces and excellent tensile performance.

Although various embodiments disclosed herein discuss residential and commercial buildings, it will be readily appreciated that the disclosed features, apparatuses, systems, and methods can similarly be used for sheds, storage units, industrial buildings, garages, and many other types of building and building components. For example, the disclosed features and embodiments can be used to construct a portion of an industrial factory. Furthermore, while wall panels and wall panel assemblies are primarily discussed herein for purposes of illustration, it will be understood that the disclosed embodiments can also be applicable to other portions of buildings, such as floors, ceilings, roofs, stairwells, ramps, and the like. Each of these building types and other types of buildings can be multi-story in nature using the various embodiments disclosed herein. Other applications, arrangements, and extrapolations beyond the illustrated embodiments are also contemplated.

### 3D-Printed Integrated Wall Panel Assemblies

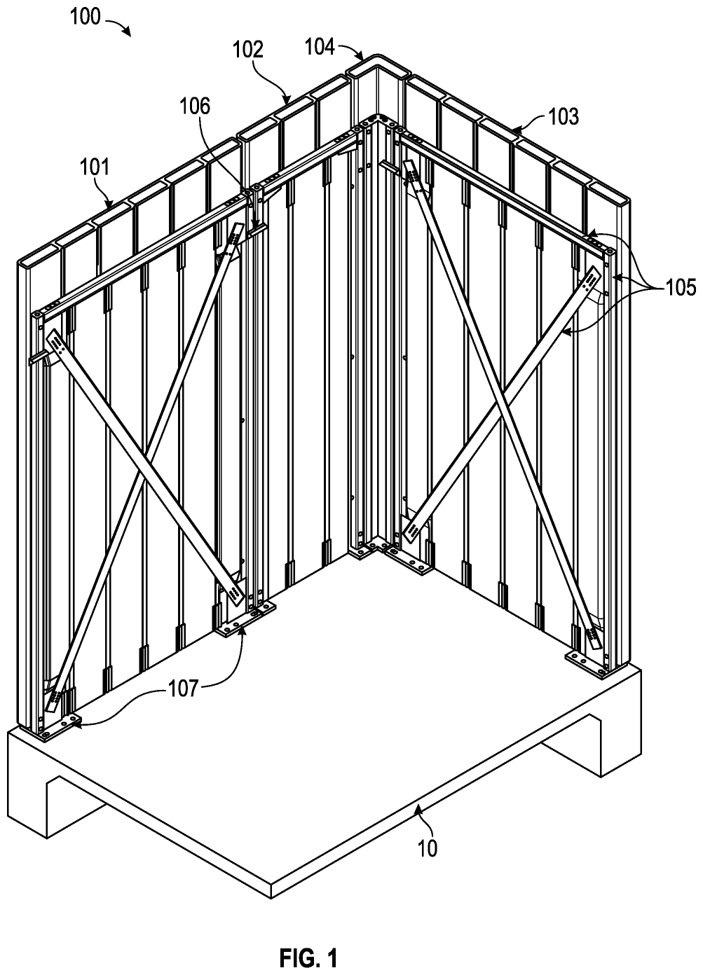

Referring first to FIG. 1, an interior region of an example 3D-printed integrated wall panel assembly is shown in rear perspective view. In some embodiments, 3D-printed integrated wall panel assembly 100 can be a building element configured to form a portion of an overall building, such as a residential or commercial building, and can meet construction industry requirements regarding structural performance, thermal efficiency, fire performance, and waterproofing, among other requirements. 3D-printed integrated wall panel assembly 100 can include a series of 3D-printed straight wall panels 101, 102, 103, and a corner wall panel 104, for example, some or all of which can be attached or otherwise coupled to one or more load transfer components 105, one or more panel connectors 106, and one or more base plates 107 to form all or part of a corner section of a building element.

Each 3D-printed wall panel 101, 102, 103, 104 can be formed by 3D printing technology using a photocurable composite material. Some or all of these 3D-printed wall panels 101, 102, 103, 104 can be integrally formed and can include an outer frame shell defining a geometric shape having an interior outer surface, an exterior outer surface, and side edges between the interior and exterior outer surfaces, and an infill structure within the outer frame shell, with the infill structure forming internal cavities within the outer frame shell, as set forth in greater detail below. While each of wall panels 101, 102, 103, 104 are noted and described as being wall panels for purposes of discussion, it will be understood that such panels can also form other building portions or components besides walls in other arrangements.

Load transfer components 105 can include, for example, one or more hollow structural section (“HSS”) columns, a set of tension transmitting members that can be pinned diagonally (e.g., structural steel X-bracing), and/or any other items suitable for load transfer. 3D-printed wall panels 101, 102, 103, 104 can be attached or otherwise coupled to each other with one or more panel connectors 106, which can include mechanical connectors located toward the tops of the walls, for example. The bottom part of each 3D-printed wall panel 101, 102, 103, 104 can be attached or otherwise coupled to a building foundation 10 by one or more base plates 107 or any other suitable connectors. 3D-printed integrated wall panel assembly 100 can also include other types of connectors, as well as other components and features, as detailed below.

Although 3D-printed integrated wall panel assembly 100 is shown as having three straight wall panels 101, 102, 103, and one corner wall panel 104 for purposes of illustration, it will be readily appreciated that more or fewer straight wall panels and/or more or fewer corner wall panels can be used in a given integrated wall panel assembly. Other types and shapes of wall panels can also or alternatively be used for a given 3D-printed integrated wall panel assembly. Furthermore, each wall panel can have the same or variable widths. For example, straight wall panels 101 and 103 are shown as having widths of six wall panel segments, while straight wall panel 102 is shown as having a width of three wall panel segments. More or fewer wall panel segments may also be used.

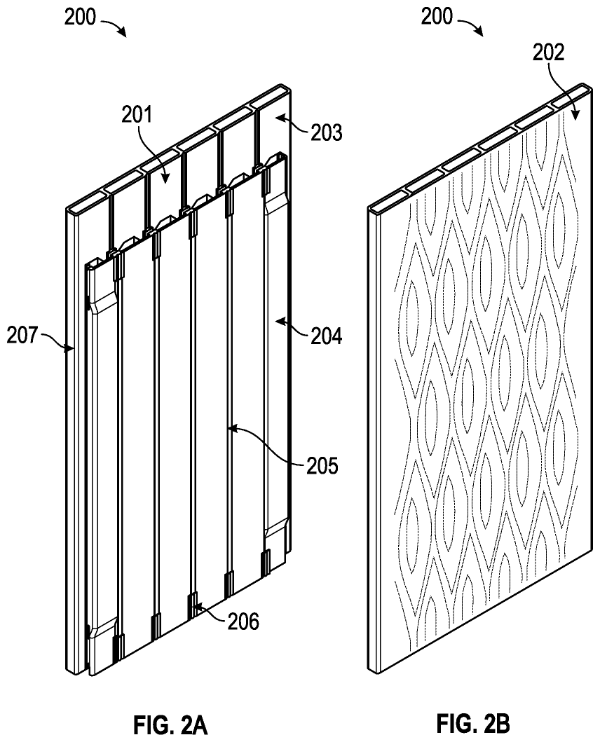

Referring next to FIGS. 2A and 2B, an example 3D-printed straight wall panel is illustrated in rear perspective and front perspective views respectively. FIG. 2A depicts an interior region of the panel that can face a building interior, while FIG. 2B depicts an exterior region of the panel that can face a building exterior. 3D-printed straight wall panel 200 can generally form a building panel configured to form a portion of an overall building, such as a residential or commercial building, and can meet construction industry requirements regarding structural performance, thermal efficiency, fire performance, and waterproofing, among other requirements. 3D-printed straight wall panel 200 can generally be a 3D-printed structure and one or more coupling features formed in the 3D-printed structure. The 3D-printed structure can be formed by 3D printing technology using a photocurable composite material, can be integrally formed, and can include an outer frame shell defining a geometric shape having an interior outer surface, an exterior outer surface, and side edges between the interior outer surface and exterior outer surface, and an infill structure within the outer frame shell, the infill structure forming internal cavities within the outer frame shell. The one or more coupling features formed in the 3D-printed structure can be configured to facilitate coupling the 3D-printed structure to one or more separate building components of the overall building, as detailed below.

3D-printed straight wall panel 200 can include internal surface 201 and external surface 202 on a single 3D-printed polymer-based composite panel. In some embodiments, external surface 202 can have various decorative elements integrally formed therewith as created by a 3D printer during printing of the entire panel 200, although such decorative elements might not have any structural or functional load bearing abilities. Since the use of 3D printing technology allows the creation of panels with complex cross-sectional geometries, 3D-printed straight wall panel 200 can be printed to form a parapet 203 at the top of the panel. 3D-printed straight wall panel 200 can also include a main body 204 that can be 3D-printed with the formation of double-layered infills 205 along the entire length of the panel and quadruple-layered infills 206 located proximate the top and bottom of the panel main body. 3D-printed straight wall panel 200 can also have one or more side extrusions located along one or more side edges 207 of the panel that form vertical decorative ledges configured to bridge juncture regions between adjacent panels, to cover columnar members from the exterior, or both.

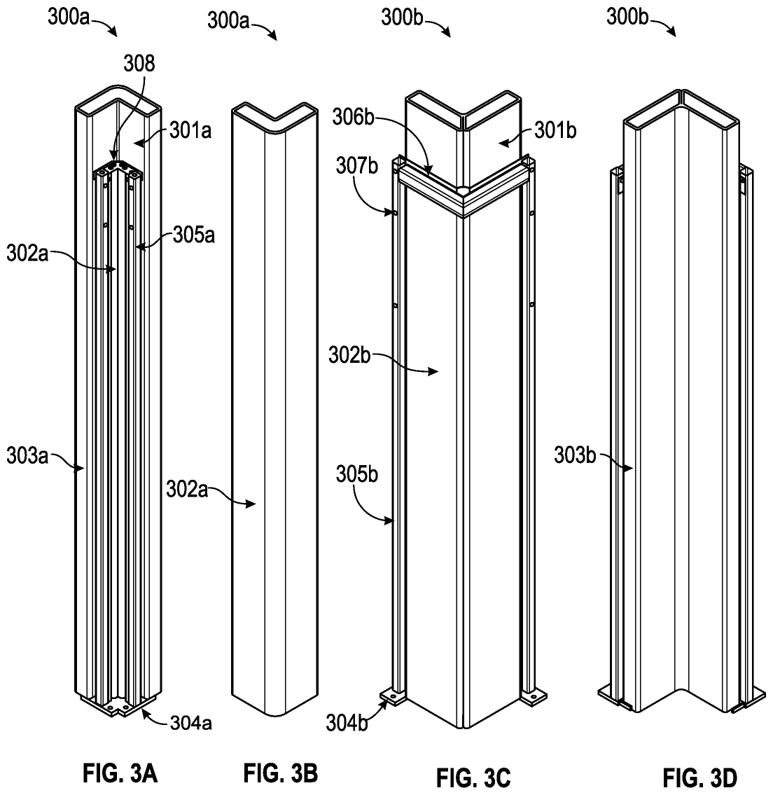

FIGS. 3A-3D depict two different types of 3D-printed integrated corner panels. FIGS. 3A and 3B illustrate interior and exterior regions of an example 3D-printed integrated outside corner wall panel 300a in rear perspective and front perspective views respectively, while FIGS. 3C and 3D illustrate interior and exterior regions of an example 3D-printed integrated inside corner wall panel 300b in rear perspective and front perspective views respectively. As in the case of 3D-printed straight wall panel 200 shown in FIGS. 2A-2B above, interior regions of a corner wall panel 300a, 300b can face a building interior, while exterior regions of the corner wall panel can face a building exterior. As in the case of 3D-printed straight wall panel 200 above, 3D-printed integrated outside corner wall panel 300a can have a 3D-printed structure that can include parapet 301a, main body 302a, and side edges 303a, while 3D-printed integrated inside corner wall panel 300b can have a 3D-printed structure that can include parapet 301b, main body 302b, and side edges 303b. One or both of 3D-printed integrated outside corner wall panel 300a and 3D-printed integrated inside corner wall panel 300b can have one or more side extrusions located along one or more side edges 303a, 303b of the corner wall panel that form vertical decorative ledges configured to bridge juncture regions between adjacent panels, to cover columnar members from the exterior, or both. The bottom portion of each 3D-printed integrated corner wall panel 300a, 300b can be coupled to a separate component of the overall building (e.g., a foundation) by one or more base plates 304a, 304b respectively.

One or both of 3D-printed integrated outside corner wall panel 300a and 3D-printed integrated inside corner wall panel 300b can also have a load transfer system formed from non-3D-printed material and coupled to its respective 3D-printed structure. Such a load transfer system can be configured to transfer loads across the 3D-printed structure, and the 3D-printed structure and the load transfer system can combine to form the 3D-printed integrated panel. Such a load transfer system can include, for example, structural steel frame 305a for 3D-printed integrated outside corner wall panel 300a or structural steel frame 305b for 3D-printed integrated inside corner wall panel 300b. Structural steel frame 305b can include top frame member 306b, one or more bottom frame members such as base plates 304b, and columnar members 307b that can extend proximate to and along side edges 303b to couple the top and bottom frame members. Structural steel frame 305a can have similar top frame, bottom frame, and columnar members arranged to fit the geometry of 3D-printed integrated outside corner wall panel 300a. One or more frame connectors 308 can couple a frame member to a respective 3D-printed structure, a separate component of the overall building, or both, as detailed below.

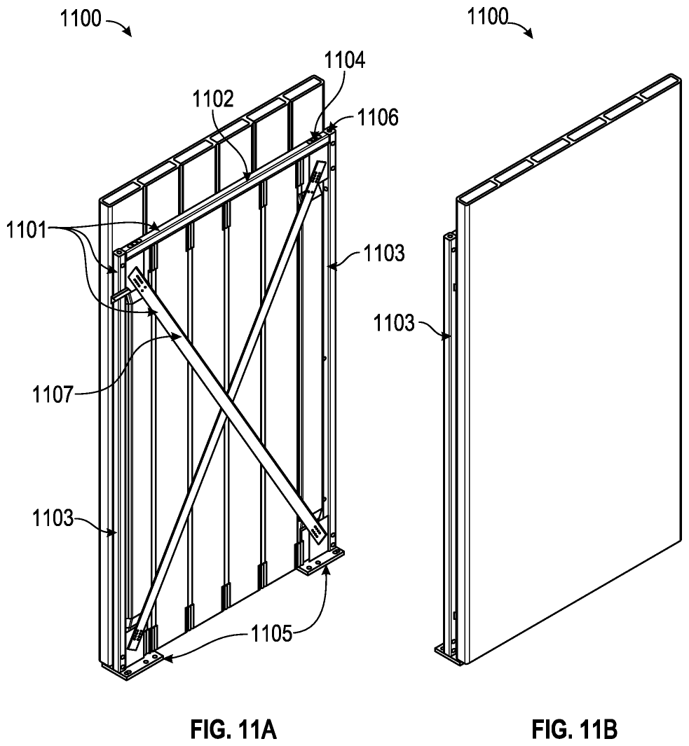

While 3D-printed corner wall panels 300a, 300b have been shown and described as integrated wall panels having a 3D-printed structure and a load transfer system formed from non-3D-printed material, it will be appreciated that some 3D-printed corner wall panels may be formed without such a load transfer system. Similarly, 3D-printed straight wall panel 200 can be a standalone 3D-printed structure as shown and described above or can be combined with one or more load transfer components and/or one or more connectors to form a 3D-printed integrated straight wall panel, various details for which are illustrated in FIGS. 11A and 11B below. Other panel shapes beyond straight and corner wall panels are also contemplated, such as curved, wavy, round-cornered, and square-cornered panels, for example, and the various features and structures disclosed herein can be extrapolated to fit such other panel shapes.

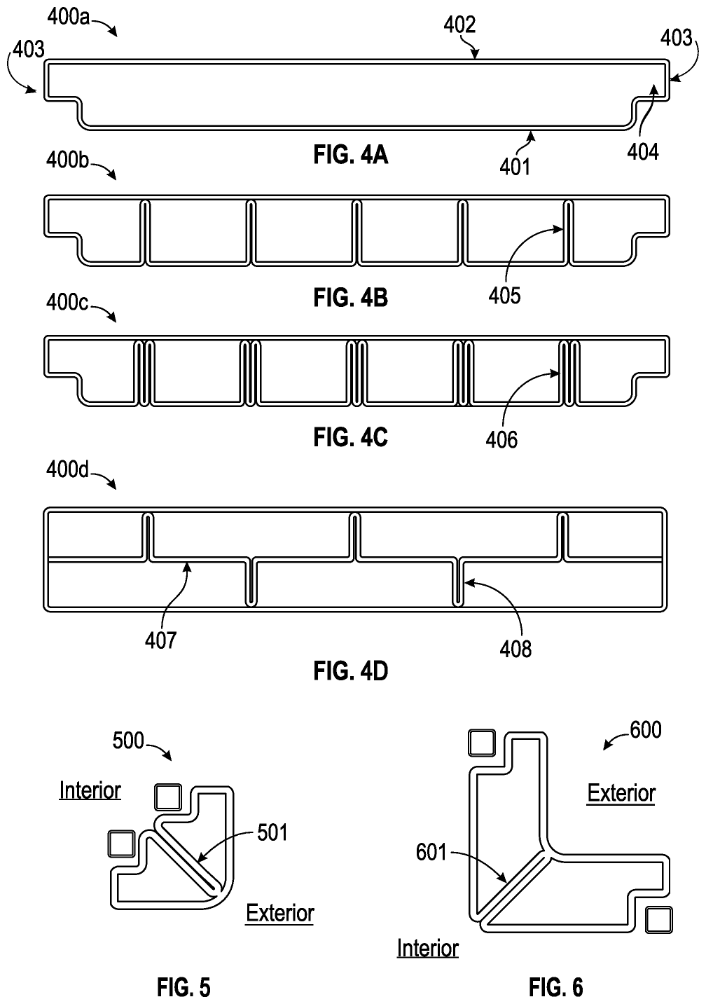

Each of the foregoing straight and corner wall panels can have a 3D-printed structure that includes an infill structure located within its outer shell. By applying an optimized or varied infill structure, various structural properties of a given 3D-printed structure can be modified or controlled. This can include structural rigidity, for example, among other structural properties. Continuing with FIGS. 4A-4D, various examples of 3D-printed straight wall panels with varying infill structures in order of increasing wall stiffness are all shown in top cross-section views. 3D-printed straight wall panel 400a of FIG. 4A can include an outer frame shell defining a geometric shape having interior outer surface 401, exterior outer surface 402, and side edges 403 between the interior and exterior outer surfaces. In some arrangements, one or more side edges 403 can include extrusions 404 that form vertical decorative ledges configured to bridge juncture regions between adjacent 3D-printed panels. Each of 3D-printed straight wall panels 400b, 400c, and 400d shown in FIGS. 4B, 4C, and 4D respectively can similarly include an outer frame shell defining a geometric shape having an interior outer surface, exterior outer surface, and side edges, although panel 400d does not include extrusions at its side edges. Similar to foregoing examples, each interior outer surface can face a building interior, while each exterior outer surface can face a building exterior. Other arrangements are also possible.

As shown in FIG. 4A, 3D-printed straight wall panel 400a can simply be an outer frame shell that is hollow inside (i.e., one large internal cavity) without any infill structure located between interior outer surface 401 and exterior outer surface 402. In various other embodiments, however, a plurality of internal cavities can be disposed between the interior and exterior outer surfaces of the outer frame shell by printing one or more infill structures having various geometries, such as rectangular geometric, honeycomb, zig-zag infill, and wavy, among other possible simple and complex geometries. Infill structures can be integrally formed with the outer frame shell into a combined 3D-printed panel.

3D-printed straight wall panel 400b of FIG. 4B depicts an alternative embodiment of the same outer frame shell having an infill 405 that can be obtained by passing a printing head from its interior outer surface to its exterior outer surface and back to the interior inner surface, which results in the formation of a double print layer. Each of these double print layers can define a separate infill 405, and all of these double print layers can combine to form a collective infill structure for the entire 3D-printed straight wall panel 400b.

FIG. 4C depicts a 3D-printed straight wall panel 400c of the same outer frame shell having an alternative type of infill 406 that has been thickened by using a double printing head path (i.e., four layers) to reinforce the support sites of the panel. Each of these quadruple print layers can define a separate infill 406, and all of these quadruple print layers can combine to form a collective infill structure for the entire 3D-printed straight wall panel 400c. Other types and shapes of infills are also possible, as will be readily appreciated.

As shown in FIGS. 4B and 4C, the respective infill structures can result in the formation of a plurality of internal cavities disposed within the outer frame shells of 3D-printed straight wall panels 400b and 400c. In some arrangements, a filler material can be spatially disposed within some or all of these internal cavities. Such a filler material can be an insulating material such as foamed plastic insulation or any type of loose-fill insulation material. In some embodiments, one or more regions of the outer frame shell can include a cavity, indentation, or opening that can be configured for placement or installation of a separate building component, such as an electrical box, plumbing item, or sensor device, for example, among other possible building components.

Under leeward wind loading, destruction of wall panels can occur along one or more features (such as slots) formed to support a load transfer component (such as a steel frame) located at an interior part of the wall panel, examples of which are provided below. This can make wall panel performance under wind load resistant to temperature extremes and adverse weather conditions, among other factors. By varying the structure and the contact area of the infill with the outer frame shell of the wall panel, it is possible to increase the performance of the wall panel under wind load. Various types of infill can be used for this purpose. One type of infill 405 is shown in FIG. 4B and can be made by applying a double-printed layer, while a second type of infill 405 is shown in FIG. 4C and can be thickened by using a double printed head path (i.e., quadruple layer) in order to strengthen the panel support sites. Locally increased infill thickness can result in a 10-15% increase in the ultimate strength of the panel support sites. Again, other types and shapes of infills are also possible, as will be readily appreciated.

A 3D-printed infill structure within an outer frame shell of a 3D-printed wall panel can also act as thermal bridging due to the thermal conductivity of the composite material being approximately 10-17 times higher than that of air or thermal insulation. The thermal bridge formed by an infill can allow heat to “short circuit” insulation. The use of 3D printing technology makes it possible to modify an infill structure and reduce the effect of the thermal bridging efficiency of a 3D-printed wall panel as may be desired for given situations.

FIG. 4D depicts a 3D-printed straight wall panel 400d having a differently shaped outer frame shell that can be designed for improved thermal characteristics by using a more complex infill geometry and increased wall thickness. Linear 3D-printed infill 407 can divide 3D-printed straight wall panel 400d along a center line into two symmetrical halves, with cross pattern infills 408 branching out perpendicular to the center line between infill 407 and the interior and exterior outer surfaces of the outer frame shell, resulting in the formation of rectangular cells in a checkerboard pattern. Two rows of rectangular sections formed by infills and filled with thermal insulation can create an internal structure with extremely improved thermal isolation performance. The thermal insulation performance of 3D-printed straight wall panel 400d as shown with its internal cavities filled with high-density polyurethane foam can have a thermal resistance ranging from 19 to 38 ft2·° F.·h/BTU, for example.

FIGS. 5 and 6 similarly illustrate in top cross-section views an example 3D-printed outside corner wall panel with an infill structure and an example 3D-printed inside corner wall panel with an infill structure respectively. 3D-printed outside corner wall panel 500 can include double-layered infill 501, and 3D-printed inside corner wall panel 600 can similarly include double-layered infill 601, both of which can be obtained by passing a printing head from its interior outer surface to its exterior outer surface and back to the interior inner surface. Multiple infills can be formed within either corner wall panel 500 or 600, and one or more double-layered and/or quadruple-layered infills can form stiffener ribs along the entire length of one or both corner panels. Other corner panel lengths and arrangements are also possible.

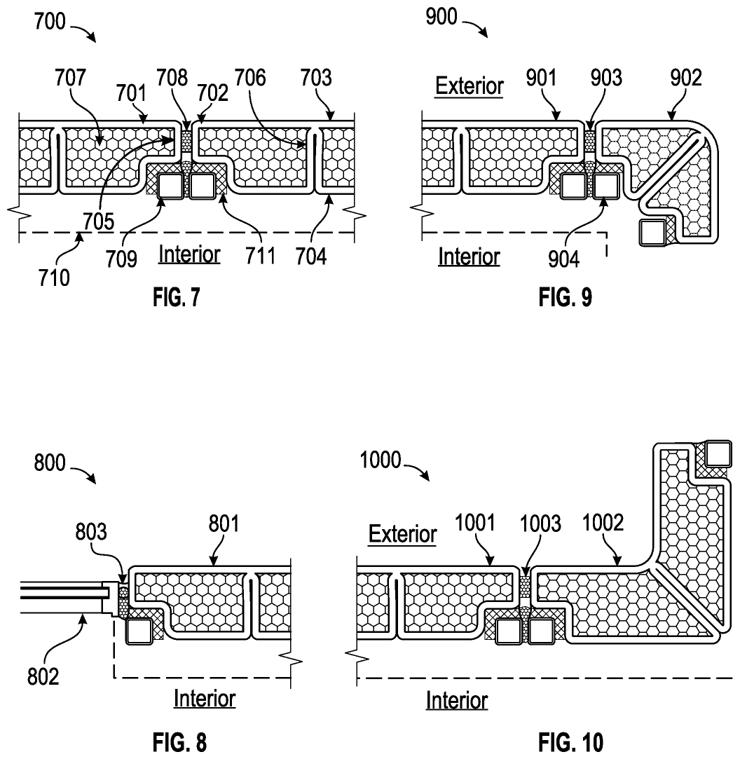

Further aspects of the present disclosure can involve various connections and other couplings between variations of the disclosed embodiments, as well as connections and other couplings between the disclosed embodiments and traditional building components such as window frames, door frames, traditional wall segments, and the like. Transitioning now to FIGS. 7-10, example juncture regions between a 3D-printed integrated straight wall panel and various other components are illustrated in top cross-section views.

FIG. 7 shows an example juncture region 700 between two 3D-printed integrated straight wall panels 701, 702. Each 3D-printed integrated straight wall panel 701, 702 can have a 3D-printed panel including an exterior outer surface 703, an interior outer surface 704, and one or more side edges 705 that form an outer frame shell, as well as one or more infills 706 within the outer frame shell. Each infill 706 can be obtained by passing off a printing head to result in the formation of a double print layer, for example, although other types of infill are also possible. Thermal insulation 707 can be distributed within cavities formed by the exterior outer surface 703, interior outer surface 704, one or more side edges 705, and one or more infills 706 of each 3D-printed integrated straight wall panel 701, 702. Juncture region 700 can secure 3D-printed integrated straight wall panels 701 and 702 to each other along adjacent side edges 705 of both panels, which adjacent side edges can include extrusions that form vertical decorative ledges configured to bridge juncture region 700, as shown.

One or more waterproofing components 708 can be placed between and/or coupled to side edges 705 of the 3D-printed integrated straight wall panels 701, 702. Each 3D-printed integrated straight wall panel 701, 702 can also include one or more load transfer components, such as one or more columnar members 709 that can form part of a steel frame or other load transfer system. One or more panel connectors (not shown) can couple 3D-printed integrated straight wall panels 701, 702 together (e.g., panel connector 106 as shown in FIG. 1). Each panel connector can be an elongated mechanical component having one end region sandwiched between adjacent side edges 705 of both panels 701, 702, and having an opposite end region sandwiched between columnar members 709. Other mechanical and/or adhesive based panel connector arrangements are also possible. In some embodiments, the interior outer surface 704 of each 3D-printed panel 701, 702 can be separated from an interior region of an associated building by a separate interior frame wall assembly cladded with gypsum wallboard 710, as represented by the dashed line in FIG. 7. In some embodiments, gaps between each 3D-printed panel and its respective columnar member(s) 709 can be filled with an outer insulation material 711, which can be batt insulation.

FIG. 8 shows an example juncture region 800 between a 3D-printed integrated straight wall panel 801 and a window 802. 3D-printed integrated straight wall panel 801 can be substantially similar to panels 701 and 702 above. Juncture region 800 can include one or more connectors that can couple 3D-printed integrated straight wall panel 801 to window 802, such as by mechanically and/or adhesively coupling a steel frame or other load transfer component of the panel to a frame of the window. Coupling can be made along the entire length of the window 802, height of the window, or both, and can also be made along a side edge of the 3D-printed integrated straight wall panel 801. One or more waterproofing components 803 can be placed between and/or coupled to adjacent side edges of 3D-printed integrated straight wall panel 801 and a window frame or other item of window 802. In some embodiments, the interior outer surface of 3D-printed integrated straight wall panel 801 can be separated from an interior region of an associated building by a separate interior frame wall assembly cladded with gypsum wallboard as represented by the dashed line in FIG. 8, and gaps between the 3D-printed panel and its respective columnar member(s) can be filled with an outer insulation material such as batt insulation. Although window 802 is shown as part of juncture region 800, it will be readily appreciated that similar juncture regions can apply for a door, door frame, or any other traditional building component.

FIG. 9 illustrates an example juncture region 900 between a 3D-printed integrated straight wall panel 901 and a 3D-printed integrated outside corner wall panel 902. Similar to the foregoing embodiments, coupling can be along adjacent side edges of both of the 3D-printed integrated straight wall panel 901 and the 3D-printed integrated outside corner wall panel 902. One or more waterproofing components 903 can be placed between and/or coupled to these adjacent straight panel and corner panel side edges. One or more panel connectors can couple 3D-printed integrated straight wall panel 901 and 3D-printed integrated outside corner wall panel 902 together, and each such panel connector can be an elongated mechanical component having one end region sandwiched between adjacent side edges of both panels 901, 902, and having an opposite end region sandwiched between adjacent columnar members 904 of the panels. Other mechanical and/or adhesive based panel connector arrangements are also possible.

In some embodiments, the interior outer surfaces of 3D-printed integrated straight wall panel 901 and 3D-printed integrated outside corner wall panel 902 can be separated from an interior region of an associated building by a separate interior frame wall assembly cladded with gypsum wallboard as represented by the dashed line in FIG. 9, and gaps between the 3D-printed integrated wall panels 901, 902 and their respective columnar member(s) 904 can be filled with an outer insulation material such as batt insulation.

FIG. 10 illustrates an example juncture region 1000 between a 3D-printed integrated straight wall panel 1001 and a 3D-printed integrated inside corner wall panel 1002. Similar to the foregoing embodiments, coupling can be along adjacent side edges of both 3D-printed integrated wall panels 1001, 1002, one or more waterproofing components 1003 can be placed between and/or coupled to these adjacent straight panel and corner panel side edges, and one or more panel connectors can couple these wall panels together. Also similarly, the interior outer surfaces of these 3D-printed integrated wall panels 1001, 1002 can be separated from an interior region of an associated building by a separate interior frame wall assembly cladded with gypsum wallboard as represented by the dashed line in FIG. 10, and gaps between the 3D-printed integrated wall panels 1001, 1002 and their respective columnar member(s) can be filled with an outer insulation material such as batt insulation.

Referring next to FIGS. 11A and 11B, an example 3D-printed integrated straight wall panel is illustrated in rear perspective and front perspective views respectively. FIG. 11A depicts an interior region of the integrated panel that can face a building interior, while FIG. 11B depicts an exterior region of the integrated panel that can face a building exterior. As noted above, an integrated wall panel can include a 3D-printed structure and one or more additional components, such as one or more connectors, load transfer components, waterproofing components, and/or other items. As such, 3D-printed integrated straight wall panel 1100 can combine the 3D-printed straight wall panel 200 set forth above with a load transfer system that can include, for example, a structural frame 1101, tension transmitting members, 1107, or both.

Structural frame 1101 can include top frame member 1102 arranged horizontally and two or more columnar members 1103 members arranged vertically and coupled to the top frame member at their top ends by way of one or more frame member connectors 1104. Top frame member 1102 and columnar members 1103 can be HSS components formed from steel, for example. Each columnar member 1103 can be coupled at its lower end to a base plate 1105, which can also be formed from steel, and which can be configured to couple the 3D-printed integrated straight wall panel 1100 to a separate building component of the overall building, such as a foundation, for example. One or more columnar members 1103 or other structural frame components can have a connection feature 1106 configured for on-site hauling. In some embodiments, one or more tension transmitting members 1107, such as structural steel X-bracing, for example, can be provided to facilitate resistance to seismic loads and to stabilize the overall integrated assembly.

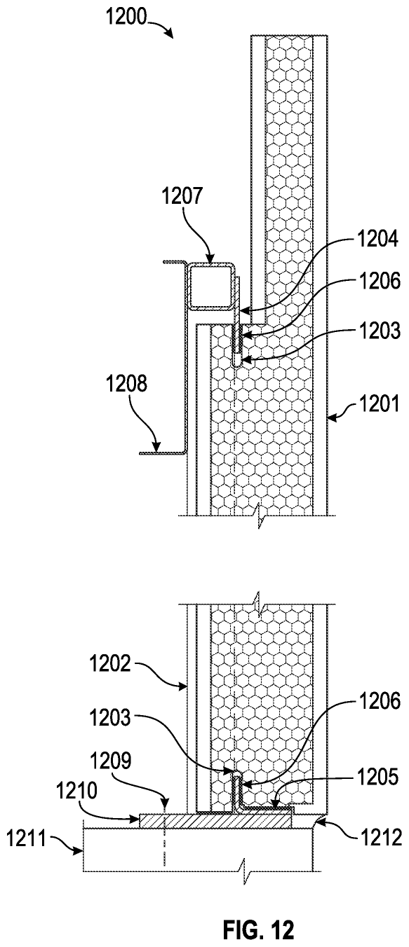

FIG. 12 illustrates in side cross-section view an example 3D-printed integrated wall panel. 3D-printed integrated wall panel 1200 can be identical or substantially similar to the 3D-printed integrated straight wall panel 1100 as set forth above. As shown, 3D-printed wall panel body 1201 can be coupled to structural frame 1202 using one or more coupling features 1203 formed into the 3D-printed material along inner top and bottom regions of the wall panel body. Coupling features 1203 can form continuous vertically oriented slots or U-shaped grooves that can be cut across one or more 3D-printed stiffener ribs or infills formed in the 3D-printed material of wall panel body 1201. These coupling features 1203 can essentially form vertical depressions that are configured to accept one or more flat insertion plates 1204 along the inner top region of wall panel body 1201 and one or more rolled angle insertion plates 1205 along the bottom region of the wall panel body.

In various embodiments, the one or more flat insertion plates 1204 and one or more rolled angle insertion plates 1205 can be formed from steel, although other suitable materials are also possible. One or more silicone rubber inserts 1206 can be inserted into the coupling features 1203 along with the flat insertion plates 1204 and rolled angle insertion plates 1205 for better grip between the insertion plates and the wall panel body 1201. One or more dimensions of coupling features 1203 formed in the wall panel body 1201 can be selected taking into account various factors, such as the difference in the coefficient of linear thermal expansion of the 3D-printed panel material, the insertion plate material, and/or the silicone rubber insert material. In accordance with some conditions, the depth of each vertically oriented slot, U-shaped groove, or other coupling feature can be at least 7/16 inches greater than the length of a steel flat insertion plate or steel rolled angle insertion plate.

Structural frame 1202 can include a top frame member 1207, such as, for example a steel HSS column, that can be coupled to each flat insertion plate 1204, which can be a steel plate that is welded, glued, bolted, or otherwise coupled to the top frame member. Structural frame 1202 can also include one or more bottom frame members 1210 that can be coupled to one or more rolled angle insertion plates 1205 and two columnar members (not shown), which can be HSS columns 1103 as shown in FIG. 11. Each vertically oriented slot, U-shaped groove, or other coupling feature 1203 can be formed by milling at the respective inner top and bottom regions of the 3D-printed wall body 1201.

In various embodiments, a rim track 1208 can form a connector that can be coupled to top frame member 1207 or another load transfer component and can be configured to couple to a separate floor component or a separate roof component of the overall building. Rim track 1208 can be a horizontally slotted rim track made of light gauge steel that can connect top frame member 1207, top ends of the columnar members, or one or more other structural frame members for the purpose of securing roof joist assemblies. Such joist assemblies can be framed in place with rim track 1208. Movements caused by a normal wall and roof movement, such as compression or extension, can be handled by a roof joist assembly connected to structural steel frame elements via the rim track design.

One or more anchor bolts or other coupling components 1209 can be inserted into one or more base plates 1210 at the bottom of each column of structural frame 1202. These anchor bolts or other coupling components 1209 can securely attach or otherwise couple 3D-printed integrated wall panel 1200 to a separate foundation 1211 of the overall building. Horizontal joining along the bottom of 3D-printed integrated wall panel 1200 can be sealed by way of one or more waterproofing components 1212 fitted between the wall panel and foundation 1211.

In various embodiments, some or all portions of a 3D-printed integrated wall panel or wall panel assembly can be assembled remotely within a factory or other relevant location, with any remaining portions and connections being made on site during construction of an overall building. For example, a 3D-printed panel can be 3D printed remotely, vertically oriented slots, U-shaped grooves, or other coupling features can be milled into the 3D-printed panel remotely, and various flat insertion plates, rolled angle insertion plates, and silicone rubber inserts can be inserted into the coupling features remotely. One or more connectors and/or one or more load transfer components, such as a support frame, can be coupled to the 3D-printed panel remotely, and/or such items can be coupled to the 3D-printed panel at a job site. Connections to other 3D-printed panels can be made remotely and/or at the job site, and finally connections to other separate building components of the overall building can be made remotely and/or at the job site.

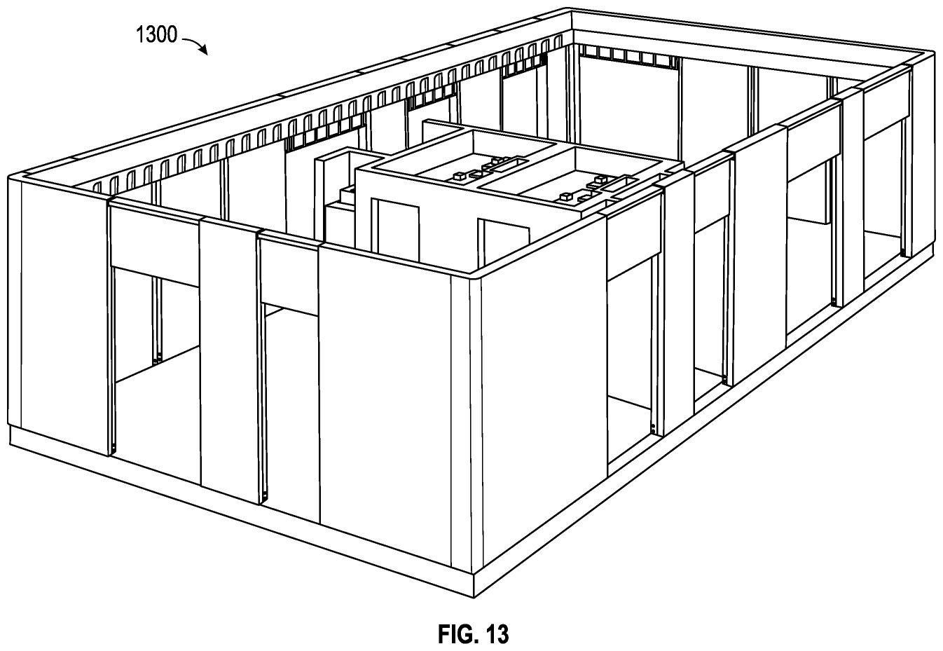

FIG. 13 illustrates in front perspective view an example building formed using 3D-printed integrated wall panel assemblies according to one embodiment of the present disclosure. Building 1300 represents just one possible building design that can be formed using the various building panels, building elements, 3D-printed integrated wall panel assemblies, and overall building panelized systems disclosed herein. As will be readily appreciated, the disclosed features, components, and systems allow for the construction of various types of houses and other buildings with various layouts. Residential, commercial, and other types of construction can greatly benefit from the application of the disclosed features, components, and systems due to ease of construction, short construction times, and the absence of construction waste.

### 3D-Printed Integrated Building Panel Systems

The foregoing embodiments can be used for the construction of various types of single story residential and commercial buildings using 3D-printed integrated wall panel assemblies and associated components. In particular, the foregoing embodiments as disclosed above include wall panels integrated with load transfer components such as tube steel structures that can be optimized for single-story buildings. The above embodiments as disclosed above may also result in a need for interior drywall to conceal underlying panel structures. In some arrangements the foregoing embodiments as disclosed can have limited design flexibility. For example, the redundant use of structural steel may be needed for some buildings higher than one story, and redundant drywall for interior finishing may be needed to conceal panel structures on the interior face of a panel.

It will be readily appreciated that some of the foregoing embodiments or at least portions thereof can be used for additional construction purposes, such as for the construction of multi-story buildings and structures, as well as building panel systems that do not require a redundant use of drywall for interior finishing. The following embodiments address these and other possibilities through the replacement or addition of alternative load transfer components, alternative 3D-printed components that are more suitable for interior finishing, and other items to form 3D-printed integrated building panel systems that are more suitable for use in multi-story structures and that are more suitable for providing interior finishing without redundant items.

The following embodiments provide 3D-printed integrated building panel systems that can use all or certain portions of the various embodiments disclosed above as well as additional components, items, features, and techniques to result in building panel systems having increased design flexibility for taller and larger structures as well as higher levels of panel completion that allow for a finished interior face of a panel. The following 3D-printed integrated building panel systems also allow for the configuration of water tight building enclosures having various interior layouts that do not rely on internal shear walls.

The following embodiments are applicable to all types of 3D-printed construction systems and provide clear advantages over existing systems. The following disclosed systems allow for increased onsite assembly speed of a water tight building envelope with an increased ability to build vertically. The following disclosed systems also allow for greater design flexibility in the form of many different floor plans, floor to ceiling heights, roof assemblies, and multi-story buildings. Additional panel schemes and systems can be designed and altered easily to incorporate different interior layouts and floor to ceiling heights, which can allow for the configuration of many different layouts to accommodate different product types. These can include multi-story single family homes, multi-story attached and detached townhomes, and multi-story multifamily homes, among other possible building types.

In general, the following 3D-printed integrated building panel systems provide super structures that can include common steel sections and that can be assembled on a variety of different foundation types. Common steel sections can include, for example, I-beams, W-beams, and/or hollow structural sections, among other types of common steel sections. Foundation types can include for example, slab, grade beam, and knee wall, among other foundation types. Assembly to foundations can be done, for example, using welding or onsite bolted connections, among other possible types of assembly.

Various 3D-printed panels can be coupled to beams, columns, or other load bearing or transfer components using mechanical fasteners. Flat panels and inside corner panels can be mechanically coupled to beam flanges using steel angles. Outside corner panels and column cover panels can be coupled to building columns using brackets that are in turn mechanically coupled to the body of hollow structural section columns and/or beam column flanges. Steel angles can be coupled to flat panels and insider corner panels via, for example, milled slots on the top and bottom of the 3D-printed panel body. Brackets can be coupled to outside corner panels and column cover panels via, for example, drilled holes in the 3D-printed panel body and mechanical hardware inserted into the drilled holes.

In addition to the various components, features, and advantages disclosed above for 3D-printed integrated wall panel assemblies, the following 3D-printed integrated building panel systems can include panels (e.g., wall panels) that are printed to include panels flanges along the panel sides and milled slots along the panel top and bottom. The panel flanges can facilitate coupling panels side-by-side, and the milled slots can accept metal angles to facilitate coupling panels to structural supports, super structures, foundations, and/or other building components that can allow for sequential coupling of panel structures to form a building envelope. The panel flanges can also allow for a recess for vertical structural columns and the concealment of various building components, such as pipes and electrical lines, for example. Other added components, features, and advantages for the following 3D-printed integrated building panel systems will be understood from the following detailed description and associated drawings.

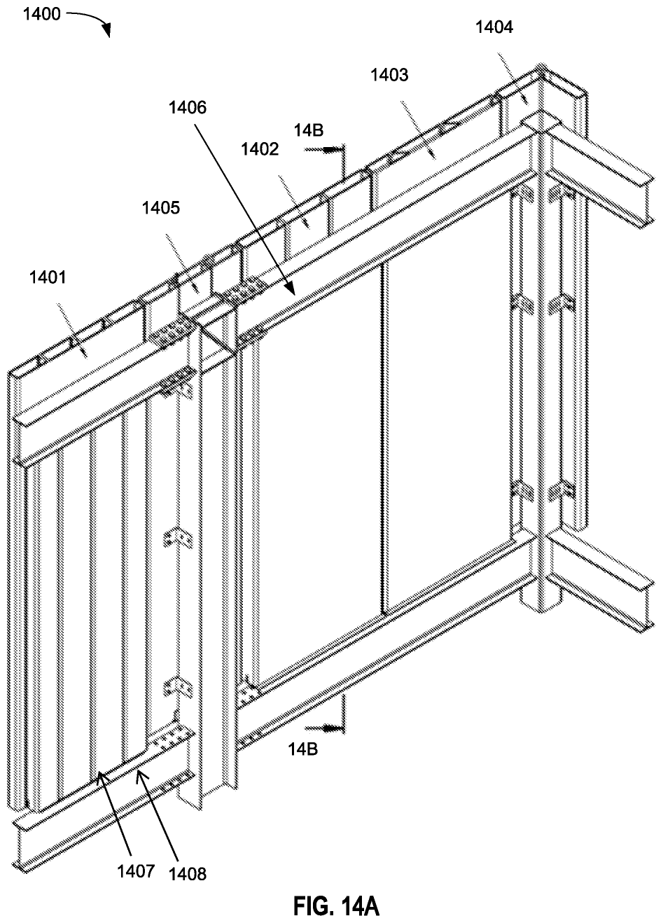

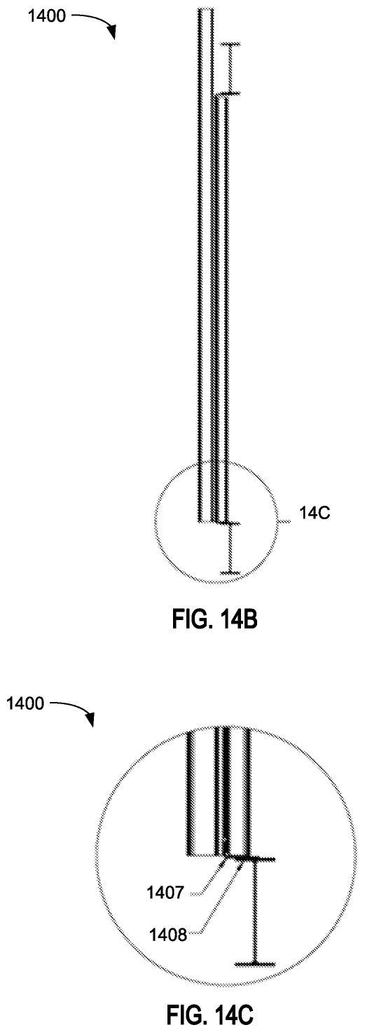

Transitioning to FIG. 14A, an interior region of an example 3D-printed integrated building panel system is illustrates in rear perspective view. 3D-printed integrated building panel system 1400 can be similar in some regards to 3D-printed integrated wall panel assembly 100 shown and described above. As in the foregoing example, 3D-printed integrated building panel system 1400 can be a building element, portion, or system configured to form a portion of an overall building, such as a residential or commercial building, and can meet construction industry requirements regarding structural performance, thermal efficiency, fire performance, and waterproofing, among other various requirements. FIG. 14B illustrates in side cross-section view the system of FIG. 14A along section line 14B, while FIG. 14C illustrates in side cross-section view a bottom portion of the system of FIG. 14B in close-up circle 14C.

3D-printed integrated building panel system 1400 can include a series of 3D-printed panels such as straight panels 1401, 1402, 1403, a corner panel 1404, and a column hider panel 1405, among other types of possible 3D-printed panels. Some or all of these panels can be coupled to one or more load transfer components 1406, one or more panel connectors (not shown), and one or more base plates 1407 to form all or part of a corner section of a building element, as shown. Base plates 1407 can then be coupled to one or more foundational or other base structural components 1408. Load transfer components 1406 can include common steel sections such as, for example, I-beams, W-beams, and/or hollow structural sections, among other types of common steel sections, and these can be arranged horizontally and/or vertically and can be coupled to each other to form one or more frame support structures.

In some arrangements, corner panel 1404 and column hider panel 1405 can be attached directly to one or more load transfer components 1406 that form structural columns, such as an I-beam and hollow structural section, as shown. Attachment can be facilitated by using embedded anchors and fasteners attached to structural clips coupled to the structural columns, for example, although other attachment or coupling types can be used. Each of straight panels 1401, 1402, 1403 can then be coupled along its sides to each other, to corner panel 1404, and/or to column hider panel 1405. The bottom of each panel 1401, 1402, 1403, 1404, 1405 can be coupled to one or more base plates 1407, which can be steel angles, for example. These base plates 1407 can then be coupled to an overall building structural component, such as a building foundation on the ground floor or a super structure beam on a higher floor. Structural columns can be coupled to the building foundation at the ground floor by way of structural base plates or other suitable fastening or coupling components.

As in the wall panel assembly embodiments detailed above, each 3D-printed panel 1401, 1402, 1403, 1404, 1405 in system 1400 can be formed by 3D printing technology using a photocurable composite material. Again, some or all of these panels can be integrally formed and can include an outer frame shell defining a geometric shape having an interior outer surface, an exterior outer surface, and side edges between the interior and exterior outer surfaces, and an infill structure within the outer frame shell, with the infill structure forming internal cavities within the outer frame shell. Each of 3D-printed system panels 1401, 1402, 1403, 1404, 1405 can generally be identical or substantially similar in nature to 3D-printed straight wall panel 200 described and illustrated in FIGS. 2A-2B above, such that details provided in the foregoing panel assembly embodiments can also apply to these panel systems embodiments. Similarly, while the panels here are shown as wall panels for purposes of illustration, it will be understood that these panels can also form other building portions or components besides walls in other arrangements.

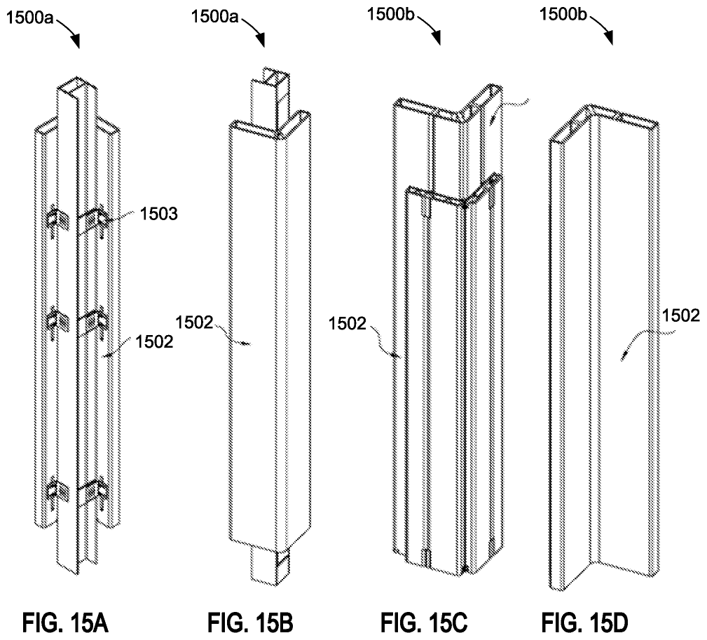

FIGS. 15A-15D depict two different types of 3D-printed integrated corner panels for an integrated building panel system. FIGS. 15A and 15B illustrate interior and exterior regions of an example 3D-printed integrated outside corner panel 1500a for a building panel system in rear perspective and front perspective views respectively, while FIGS. 15C and 15D illustrate interior and exterior regions of an example 3D-printed integrated inside corner panel 1500b for a building panel system in rear perspective and front perspective views respectively. It will be appreciated that outside corner panel 1500a can be similar to outside corner wall panel 300a above and inside corner panel 1500b can be similar to inside corner wall panel 300b above, although both corner panels can have some differences. Similar to foregoing embodiments, outside corner panel 1500a and inside corner panel 1500b can each have a 3D-printed structure that can include a parapet, a main body 1502, side edges, and side extrusions located along one or more side edges, among other possible features. In some arrangements, one or both corner panels 1500a, 1500b can be formed at a consistent thickness without a parapet.

In various embodiments, outside corner panel 1500a can be attached to one or more building columns or other vertical load transfer components by way of structural clips 1503. Again, such building columns can be vertically oriented I-beams, W-beams, and/or hollow structural sections. Other coupling arrangements between outside corner panel 1500a and one or more building columns or structural supports are also possible. In various embodiments, inside corner panel 1500b can be attached to one or more support foundations or super structure beams by way of steel angles (not shown) at the bottom of the panel. Other coupling arrangements between inside corner panel 1500b and one or more support foundations, super structure beams, or other overall building structural components are also possible.

Each of the 3D-printed system panels 1401, 1402, 1403, 1404, 1405 can have an infill structure located within its outer shell, such as a double-layered infill along its entire length, for example. Other infill structures and features can be the same or substantially similar to those described and illustrated above in FIGS. 4A-4D, such that details provided in the foregoing panel assembly embodiments can also apply to these panel systems embodiments.

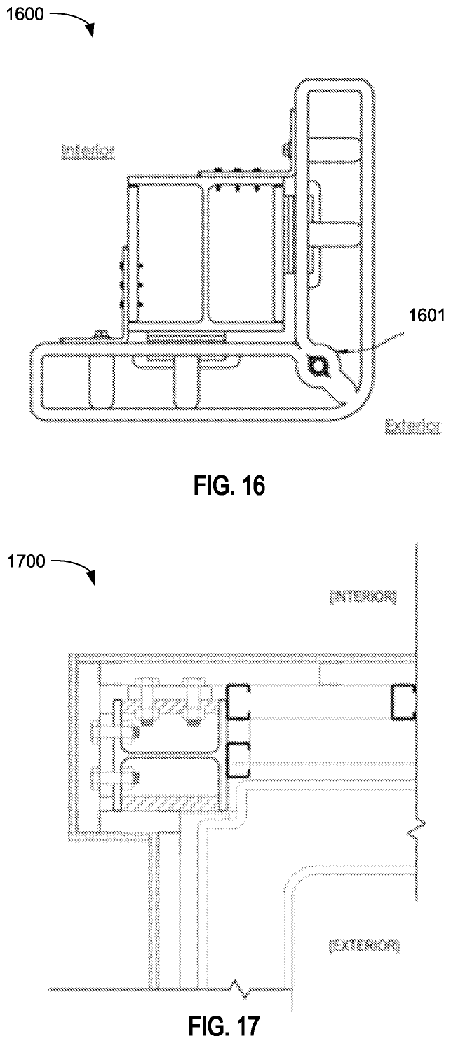

FIGS. 16 and 17 illustrate in top cross-section views an example 3D-printed integrated outside corner panel for a building panel system with an infill structure and an example 3D-printed integrated inside corner panel for a building panel system with an infill structure respectively. 3D-printed integrated outside corner panel 1600 can be similar to 3D-printed outside corner wall panel 500 disclosed above in some regards, and 3D-printed integrated inside corner panel 1700 can be similar to 3D-printed inside corner wall panel 600 disclosed above in some regards. For example, 3D-printed integrated outside corner panel 1600 can include double-layered infill 1601, and 3D-printed integrated inside corner panel 1700 can also include one or more double-layered infills, which again can be obtained by passing a printing head from its interior outer surface to its exterior outer surface and back to the interior inner surface. Multiple infills can be formed within either corner panel 1600 or 1700, and one or more double-layered and/or quadruple-layered infills can form stiffener ribs along the entire length of one or both corner panels. Other corner panel lengths and arrangements are also possible.

In some arrangements, inside corner panel 1700 can maintain a parapet and/or panel flanges at its edges. Additional arrangements are illustrated regarding coupling each of outside corner panel 1600 and inside corner panel 1700 to a respective structural support member. For example, one or more embedded anchors, bolts, fasteners, brackets, steel angles, structural clips, or other mechanical components can be used to couple printed corner panels to their respective structural columns, as shown. Again, vertical structural columns can include I-beams, W-beams, and/or hollow structural sections, among other types of common steel sections.

Various juncture regions between a 3D-printed integrated building panel system and one or more other traditional building components can be the same or similar to the example juncture regions described and illustrated above in FIGS. 7-10, such that details provided in the foregoing panel assembly embodiments can also apply to these panel system embodiments. In addition to the foregoing example junction region details, similar junction regions for a given 3D-printed integrated building panel system can also include one or more steel angles or other suitable mechanical connectors that can attach or otherwise couple the building panel system to foundation components and/or super structure beams or components of an overall building. In this regard, one or more voids can be formed at or about a printed panel edge flanges to create space for insertion or coupling with column supports or other foundation or super structure members for added vertical support for the building panel system. Again, such voids can also be used to create space for other building components, such as building MEP lines, low voltage wiring, electrical lines, piping, and other building components, as will be readily appreciated.

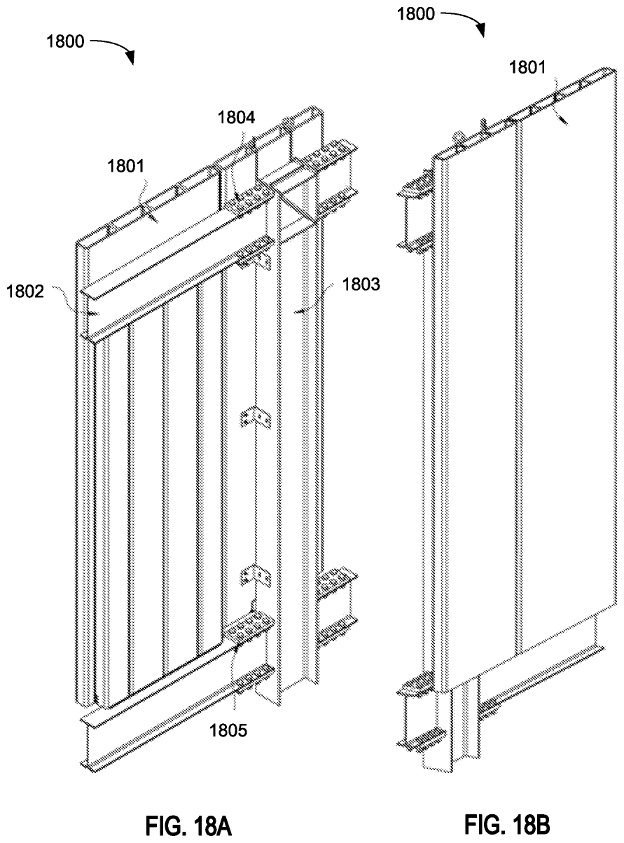

Turning next to FIGS. 18A and 18B, an example 3D-printed integrated straight building panel for a 3D-printed integrated building panel system is illustrated in rear perspective and front perspective views respectively. FIG. 18A depicts an interior region of the panel that can face a building interior, while FIG. 18B depicts an exterior region of the panel that can face a building exterior. Again, an integrated panel can include a 3D-printed structure and one or more additional components, such as one or more connectors, load transfer components, waterproofing components, and/or other items. As such, 3D-printed integrated straight building panel 1800 can combine a 3D-printed straight panel 1801 with a load transfer system that can include, for example, a super structure frame or portions thereof. 3D-printed straight panel 1801 can be the same or similar to 3D-printed straight wall panel 200 described and illustrated above in FIGS. 2A-2B, such that details provided in the foregoing panel assembly embodiments can also apply to these panel system embodiments. It will be readily appreciated that suitable variations may be possible for a given printed panel, and that similar arrangements for an integrated panel system or system component can be formulated for corner panels or for column hider panels by suitably extrapolating the components shown in this illustrative example.

A super structure frame or portion thereof for a 3D-printed integrated panel 1800 as shown can include one or more horizontally arranged beams 1802, one or more columnar members 1803, frame connection components 1804, and base connection components 1805, among other possible items. Horizontally arranged beams 1802 can be configured to carry loads from coupled printed panels and other integrated system components, and can be steel beams such as, for example, I-beams, W-beams, and/or hollow structural sections, among other types of common steel sections. Columnar members 1803 can be vertically arranged and configured to carry vertical loads, and can similarly be steel beams such as, for example, I-beams, W-beams, and/or hollow structural sections, among other types of common steel sections.

Frame connection components 1804 can be arranged to couple 3D-printed straight panel 1801 to one or more horizontally arranged beams 1802 and columnar members 1803, as well as to couple horizontal beams and columnar members to each other. Frame connection components 1804 can include any suitable mechanical connecting items, such as brackets, plates, angles, bolts, screws, welds, adhesives, and the like. Base connection components 1805 can couple horizontal beams, columnar members, and/or printed panels to a foundation or other extended super structure component. Base connection components 1805 can include base steel plates, for example, as well as any other suitable mechanical connector.

In some arrangements, one or more horizontally arranged beams 1802 and/or one or more columnar members 1803 can be adapted to form a portion of an overall building super structure, such as by coupling these items to other building super structure items that are not part of a given integrated building panel system to transfer loads across the coupled items from the given building panel system to the rest of the building. This can allow for improved modularity for a 3D-printed integrated building panel system in that its load transfer components (e.g., horizontal beams 1802 and columnar members 1803) can form overall building super structure components that can be coupled on site to other building super structure components without requiring extra super structure items and added construction steps.

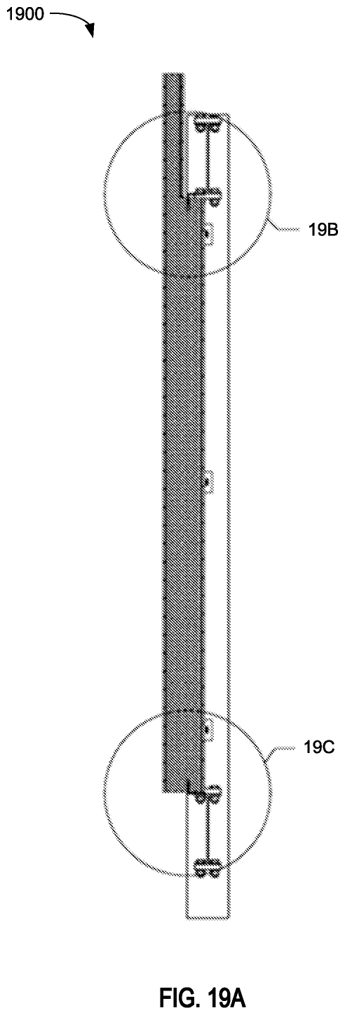

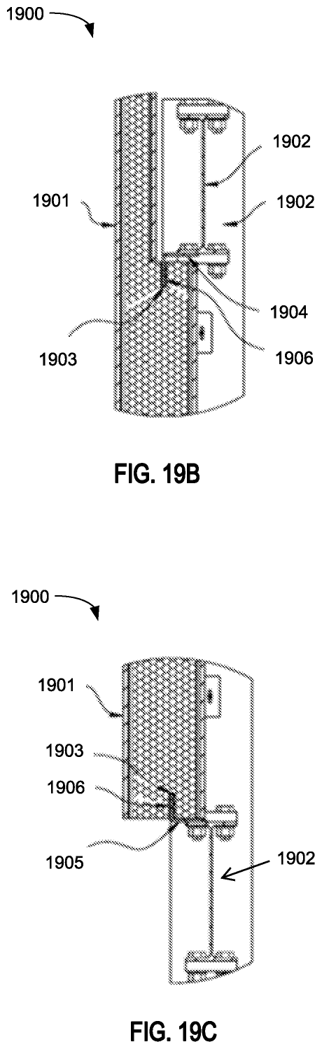

Continuing with FIG. 19A, an example 3D-printed integrated building panel is shown in side cross-section view. 3D-printed integrated building panel 1900 can be identical or substantially similar to 3D-printed integrated straight building panel 1800 as set forth above. As shown, the 3D-printed building panel can be coupled in a secured fashion to building foundation components, building super structure components, and/or other structural support components using one or more mechanical coupling components and coupling features formed into the 3D-printed material along inner top and bottom regions of the building panel body, as set forth in greater detail below. It will be readily appreciated that suitable variations may be possible for a given printed panel, and that similar arrangements for an integrated building panel or other system component can be formulated for corner panels or for column hider panels by suitably extrapolating the components shown in this illustrative example. FIG. 19B illustrates in side cross-section view a top portion of the integrated building panel of FIG. 19A in close-up circle 19B, while FIG. 19C illustrates in side cross-section view a bottom portion of the integrated building panel of FIG. 19A in close-up circle 19C.

As shown in FIGS. 19B and 19C, 3D-printed building panel body 1901 can be coupled to structural frame components 1902 using one or more coupling features 1903 formed into the 3D-printed material along inner top and bottom regions of the printed building panel body. As noted above, structural frame components 1902 can be horizontally arranged steel beams configured to carry loads from coupled printed panels and other integrated system components. While structural steel frame components 1902 can be I-beams as shown, it will be readily appreciated that W-beams, hollow structural sections, or other types of common sections made from steel or any other suitable metal or strong material can alternatively be used.

Coupling features 1903 can form continuous vertically oriented slots or U-shaped grooves that can be cut across one or more 3D-printed stiffener ribs or infills formed in the 3D-printed material of building panel body 1901. These coupling features 1903 can essentially form vertical depressions that are configured to accept one or more mechanical coupling components 1904, 1905 along the top and bottom regions of building panel body 1901. These can be any suitable mechanical coupling components, such as flat or rolled angle insertion plates. In one specific example, mechanical coupling components 1904 can be top rolled angle insertion plates and mechanical coupling components 1905 can be bottom rolled angle insertion plates. Such rolled angle insertion plates can be formed from steel, although other suitable materials are also possible. One or more silicone rubber inserts 1906 can be inserted into the coupling features 1903 along with the rolled angle insertion plates or other mechanical coupling components 1904, 1905 for better grip between the coupling components and the wall panel body 1901.

Various additional details set forth above with respect to 3D-printed integrated wall panel 1200 can similarly be applied for 3D-printed integrated building panel 1900. For example, various dimensions of coupling features 1903 and/or coupling components 1904 can be selected taking into account various factors, such as the difference in the coefficient of linear thermal expansion of the 3D-printed panel material, the coupling component material, and/or the silicone rubber insert material. The depth of each vertically oriented slot, U-shaped groove, or other coupling feature 1903 can be greater than the length of a steel insertion plate or other coupling component, such as a depth of at least 7/16 inches, for example. Other examples of foregoing details that can also apply to building panel systems can include various ways in which coupling components 1904 are attached or otherwise coupled to structural frame components 1902, various ways of forming coupling features 1903 in the printed material, various uses of rim tracks, anchor bolts, and waterproofing features, and the ability to form 3D-printed integrated building panels 1900, 3D-printed integrated building panel systems 1400, and other disclosed components and features remotely such that these components, panels, and systems can be readily assembled on site in modular fashion during overall building construction.

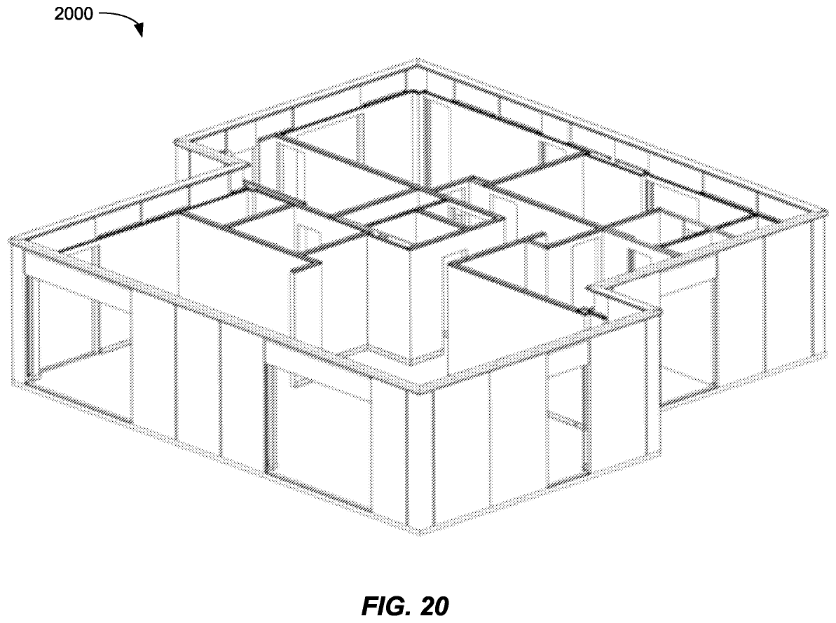

Lastly, FIG. 20 illustrates in front perspective view an example building formed using 3D-printed integrated building panel systems. Building 2000 represents just one possible building design that can be formed using the various building panels, components, features, and overall 3D-printed integrated building panel systems disclosed herein. As will be readily appreciated, the disclosed 3D-printed integrated building panel systems and the various features and details thereof allow for the construction of various types of houses and other buildings with different design layouts, which can include multi-story as well as single story buildings.

In particular, the disclosed building panel systems can include 3D-printed building panels that include straight, corner, and hider panels, some or all of which can be printed with slots and holes and/or can be milled or drilled after printing to form slots or holes as described above. The disclosed systems can also include prefabricated modular super structures or portions thereof including beams, columns, and mechanical coupling components, which can include steel I-beams, W-beams, and/or hollow structural sections, as well as steel connection brackets and class A structural bolts and nuts. The super structures can be modular in nature to facilitate ready assembly into other building sections and can allow for universal code compliant solutions for ease of deployment in many different regions. In some arrangements, panel heights, widths, and depths can be altered or adjusted to allow for different environmental performance aesthetics (e.g., R value), floor plans, and elevations based on design requirements.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A 3D-printed integrated building panel system configured to form a portion of an overall building, the system comprising:
a plurality of 3D-printed building panels formed by 3D printing technology using a photocurable composite material, wherein at least a portion of the 3D-printed building panels is integrally formed;
a plurality of connectors coupled to one or more of the 3D-printed building panels and configured to couple the 3D-printed building panels to each other, to one or more separate building components of the overall building, or to any combination thereof; and
one or more load transfer components coupled to one or more of the 3D-printed building panels and configured to transfer loads across the 3D-printed building panels, wherein the one or more load transfer components are configured to form at least a portion of an overall super structure for the overall building.

2. The system of claim 1, wherein the 3D-printed integrated building panel system forms a modular unit configured to be readily installed to the overall building during construction.

3. The system of claim 1, wherein the one or more load transfer components include one or more horizontally oriented beams, one or more vertically oriented columnar members, or both.

4. The system of claim 1, wherein the one or more load transfer components combine to form a frame support super structure.

5. The system of claim 1, wherein the one or more load transfer components include one or more steel I-beams, W-beams, hollow structural sections, or any combination thereof.

6. The system of claim 1, wherein the plurality of 3D-printed building panels includes at least one straight panel, at least one corner panel, and at least one column hider panel.

7. The system of claim 1, wherein at least one of the 3D-printed building panels includes one or more vertically oriented slots formed into its top surface, its bottom surface, or both, and wherein the one or more vertically oriented slots are configured to accept one or more connectors inserted therein to facilitate coupling to one of the load transfer components.

8. The system of claim 1, wherein at least one of the 3D-printed building panels includes an outer frame shell defining a geometric shape having an interior outer surface, an exterior outer surface, side edges between the interior and exterior outer surfaces, and an infill structure within the outer frame shell, the infill structure forming internal cavities within the outer frame shell.

9. The system of claim 1, wherein the 3D-printed integrated building panel system meets construction industry requirements regarding structural performance, thermal efficiency, fire performance, and waterproofing.

10. The system of claim 1, wherein the one or more separate building components of the overall building include one or more window frames, door frames, traditional wall segments, foundations, or any combination thereof.

11. The system of claim 1, wherein at least a portion of the plurality of connectors are coupled directly to at least a portion of the one or more load transfer components.

12. A building panel configured to form a portion of a 3D-printed integrated building panel system that is in turn configured to form a portion of an overall building, the building panel comprising:
a 3D-printed structure formed by 3D printing technology using a photocurable composite material, wherein the 3D-printed structure is integrally formed and includes:
an outer frame shell defining a geometric shape having an interior outer surface, an exterior outer surface, and side edges between the interior outer surface and exterior outer surface, and
one or more coupling features formed along edges of the 3D-printed structure, wherein the one or more coupling features are configured to facilitate coupling the 3D-printed structure to a load transfer component within the 3D-printed integrated building panel system, the load transfer component being configured to form at least a portion of an overall super structure for the overall building.

13. The building panel of claim 12, wherein the 3D-printed structure further includes an infill structure within the outer frame shell, the infill structure forming internal cavities within the outer frame shell.

14. The building panel of claim 12, wherein the one or more coupling features formed in the 3D-printed structure include one or more vertically oriented slots formed into top and bottom edges thereof.

15. The building panel of claim 14, wherein the one or more vertically oriented slots are configured to accept one or more connectors inserted therein to facilitate coupling the 3D-printed structure to the load transfer component.

16. The building panel of claim 12, wherein the building panel forms a modular unit configured to be readily installed to the 3D-printed integrated building panel system.

17. The building panel of claim 12, wherein the load transfer component is a horizontally oriented beam or a vertically oriented columnar member.

18. The building panel of claim 12, wherein the load transfer component is a steel I-beam, W-beam, or hollow structural section.

19. The building panel of claim 12, further comprising:
the load transfer component.

20. The building panel of claim 12, wherein the interior outer surface, the exterior outer surface, or both are covered by one or more finishing coatings.
